(19) United States
(12) Patent Application Publication
(10) Pub. No.: US 2012/0261356 A1
(43) Pub. Date: Oct. 18, 2012

(54) DEVICE HAVING SOLID-LIQUID SEPARATION FUNCTION, MICRO-TAS DEVICE, AND SOLID-LIQUID SEPARATION METHOD

(75) Inventor: Hiroshi Tsutsui, Osaka (JP)

(73) Assignee: JOSHO GAKUEN EDUCATIONAL FOUNDATION, Osaka-shi, Osaka (JP)

(21) Appl. No.: 13/518,413

(22) PCT Filed: Dec. 20, 2010
(86) PCT No.: PCT/JP2010/072887

§ 371 Date: Jun. 22, 2012

(30) Foreign Application Priority Data
Dec. 25, 2009 (JP) 2009-293605

(51) Int. Cl. B01D 43/00

(52) U.S. Cl. 210/767; 210/335

(57) ABSTRACT

In a device having a solid-liquid separation function, a solid-liquid mixture is introduced through a lid inlet formed in a lid, a separation portion for solid-liquid separation is formed in a groove portion, and solid trapping portions are arranged in the separation portion. Each solid trapping portion is formed of a partition wall and includes an inlet portion, an accommodating portion which accommodates one or more solids that have entered through the inlet portion, and an opening portion which is formed on a downstream side of the accommodating portion and prevents the solid having a fixed size or larger from passing therethrough. A width of a region of the separation portion where the solid trapping portions are formed is narrow on a downstream side compared to on an upstream side.

### TECHNICAL FIELD

The present invention relates to a device having a solid-liquid separation function, particularly to a device having a function of filtering out solids having a fixed size or larger from a mixture of liquid and solids, for example, a filtering function having a function of separating blood corpuscles from blood (solid-liquid separation function), a μ-TAS (Micro Total Analysis Systems) device having a filtering function, and a solid-liquid separation method.

### BACKGROUND ART

Recently, there has been studied and developed a micro chemical device which is called a μ-TAS (μ-Micro Total Analysis Systems) where equipment or a technique used in chemical analysis or synthesis is micronized by making use of a micromachining technique. The μ-TAS has several advantages such as an advantage that just a small amount of specimen is required, an advantage that a reaction time is short and an advantage that the μ-TAS is suitable for analysis. Accordingly, it is expected that the μ-TAS is used in medical fields such as blood analysis. In this case, in performing the blood analysis, it is necessary to carry out the separation of blood corpuscles from blood as preprocessing. However, it is difficult to simply install a filter in a micrometer-sized flow passage. For example, mounting of a non-woven fabric or the like as a filter in a flow passage without causing leakage of liquid is difficult because of a miniature size of the flow passage. Further, the μ-TAS has a drawback that its manufacturing cost is pushed up. Still further, the μ-TAS has a drawback that an entry portion of a filter portion is likely to be clogged with blood corpuscles thus deteriorating filtering efficiency.

To overcome these drawbacks, patent document 1 proposes a device having a solid-liquid separation function. That is, patent document 1 discloses the device having a solid-liquid separation function where a hollow portion through which a fluid flows is formed on a planar body, an inlet for fluid is formed in one end portion of the hollow portion, and an outlet is formed in the other end of the hollow portion. The inlet is an introducing port for introducing a solid-liquid mixture. A separation portion for separating the mixture into a liquid and solids by trapping solids having a fixed size or larger is formed in the groove. Due to the pressure difference between the inlet and the outlet, the solid-liquid mixture is made to flow in the hollow portion from an inlet side to an outlet side through the separation portion from an upstream side to a downstream side. A plurality of solid trapping portions are formed in the separation portion. The solid trapping portion is constituted of a bottom portion of the hollow portion and partition walls which prevent solids having a fixed size or larger from passing therethrough. The solid trapping portion further includes an inlet portion which allows solids having a fixed size or larger to pass therethrough, an accommodating portion which accommodates one or more solids which enter the accommodating portion from the inlet portion, and an opening portion which is provided downstream of the accommodating portion with an opening smaller than the solids in size.

In the device disclosed in patent document 1, a width of a region of the separation portion where the solid trapping portions are formed remains the same throughout from an upstream side to a downstream side. That is, although a downstream portion of the separation portion 5 is gradually narrowed as shown in FIG. 1 of patent document 1, this portion is a portion downstream of the region of the separation portion where the solid trapping portions are formed, and the region of the separation portion where the solid trapping portions are formed has the same width from an upstream side to a downstream side. Further, as also shown in FIG. 7 of patent document 1, a trunk portion 54 of the separation portion which is a region where the solid trapping portions are formed also has the same width from an upstream side to a downstream side. The same also goes for FIG. 8 of patent document 1.

Although the device disclosed in patent document 1 overcomes drawbacks such as clogging of blood corpuscles, there has been a demand for a device having a high solid-liquid separation function which can exhibit higher collection efficiency of a liquid separated from a solid-liquid mixture for performing an accurate analysis using a small amount of sample.

### PRIOR ART DOCUMENT

### Patent Document

Patent document 1: JP-A-2009-109232

### SUMMARY OF THE INVENTION

### Problems that the Invention is to Solve

The present invention has been made in view of the above-mentioned drawbacks, and it is an object of the present invention to provide an easily-manufactured and inexpensive miniaturized device having a filtering function (solid-liquid separation function) where by only having a solid-liquid mixture flow in a path, solids are carried away by an energized flow of the liquid, and only solids having a fixed size or larger are efficiently trapped and separated in the course of the flow of the liquid, and more particularly to a device which exhibits high collection efficiency of a separated liquid, a μ-TAS (Micro Total Analysis Systems) device having a filtering function, and a solid-liquid separation method.

### Means for Solving the Problems

The invention described in claim 1 is directed to a device having a solid-liquid separation function which is provided with a separation portion for separating solids and a liquid from each other by trapping the solids having a fixed size or larger, wherein a solid-liquid mixture is made to pass through the separation portion toward a downstream from an upstream in the direction from an inlet side to an outlet side, a plurality of solid trapping portions are arranged in a space which is formed in the separation portion in a sandwiched manner between one face and the other face which faces each other, the solid trapping portion is formed of partition walls extending toward the other face from one face, and includes an inlet portion, an accommodating portion which accommodates one or more solids which enters the accommodating portion through the inlet portion, and an opening portion which is formed on a downstream side of the accommodating portion and prevents the solid having a fixed size or larger from passing therethrough, and a width of a region of the separation portion where the solid trapping portions are formed is narrow on a downstream side compared to on an upstream side.

The invention described in claim 2 is directed to the device having a solid-liquid separation function described in claim 1, wherein the partition wall is formed of a row of columnar bodies or a wall body.

The invention described in claim 3 is directed to the device having a solid-liquid separation function described in claim 1 or 2, wherein the partition wall is formed on the above-mentioned one face, and a material which forms the other face is a material softer than a material which forms the partition wall.

The invention described in claim 4 is directed to the device having a solid-liquid separation function described in claim 1 or 2, wherein the partition wall is formed on one face, and a material which forms the partition wall is a material softer than a material which forms the other face.

The invention described in claim 5 is directed to the device having a solid-liquid separation function described in claim 1 or 2, wherein the partition wall is formed on one face, and a buffer layer formed of a material softer than a material which forms the other face and a material which forms the partition wall is arranged between the partition wall and the other face.

The invention described in claim 6 is directed to the device having a solid-liquid separation function described in any one of claims 3 to 5, wherein the soft material is a resin having hardness of 10 to 100 based on a durometer scale.

The invention described in claim 7 is directed to the device having a solid-liquid separation function described in any one of claims 1 to 6, wherein a plurality of flow passages directed toward a downstream from an upstream are formed in the separation portion, the plurality of solid trapping portions which open toward the flow passages are arranged along the flow passages, and one flow passage and another flow passage are defined from each other by a barrier wall or a barrier wall having an opening portion which prevents the solid having the fixed size or larger from passing therethrough.

The invention described in claim 8 is directed to the device having a solid-liquid separation function described in anyone of claims 1 to 7, wherein the separation portion in which the width of the region where the solid trapping portions are formed is narrow on the downstream side compared to the upstream side is provided in plural on one plane, and liquids from the plurality of separation portions are merged.

The invention described in claim 9 is directed to the device having a solid-liquid separation function described in any one of claims 1 to 8, wherein the plurality of separation portions in which the width of the region where the solid trapping portions are formed is narrow on the downstream side compared to the upstream side are gathered thus forming a circular shape or an arcuate shape, and a discharge opening for a merged liquid formed of liquids from the plurality of separation portions is formed at a center portion of a circle or an arc.

The invention described in claim 10 is directed to the device having a solid-liquid separation function described in any one of claims 1 to 9, wherein a most downstream portion of the separation portion is configured not to allow the solid having the fixed size or larger from passing therethrough.

The invention described in claim 11 is directed to the device having a solid-liquid separation function described in any one of claims 1 to 10, wherein a height of the space formed in a sandwiched manner between one face and the other face which faces one face in an opposed manner is 2 to 6 μm.

The invention described in claim 12 is directed to a μ-TAS (Micro Total Analysis Systems) device, wherein the μ-TAS device includes the device having a solid-liquid separation function described in any one of claims 1 to 11 as a part thereof.

The invention described in claim 13 is directed to a solid-liquid separation method which separates solids and a liquid using a device having a solid-liquid separation function described in any one of claims 1 to 11, wherein a device having a solid-liquid separation function which is provided with a separation portion having a volume capacity larger than a total volume of a solid contained in a solid-liquid mixture to be separated into solids and a liquid is prepared as the separation portion, and the solids and the liquid are separated from each other using the device having a solid-liquid separation function.

The present invention is explained in detail hereinafter. The device having a solid-liquid separation function according to the present invention described in claim 1 is the device having a solid-liquid separation function which is provided with a separation portion for separating solids and a liquid from each other by trapping the solids having a fixed size or larger, wherein a solid-liquid mixture is made to pass through the separation portion toward a downstream from an upstream in the direction from an inlet side to an outlet side, a plurality of solid trapping portions are arranged in a space which is formed in the separation portion between one face and the other face which faces one face in an opposed manner, the solid trapping portion is formed of partition walls extending toward the other face from one face, and includes an inlet portion, an accommodating portion which accommodates one or more solids which enters the accommodating portion through the inlet portion, and an opening portion which is formed on a downstream side of the accommodating portion and prevents the solid having a fixed size or larger from passing therethrough, and a width of a region of the separation portion where the solid trapping portions are formed is narrow at a downstream side compared to on an upstream side.

In the present invention, the solid-liquid mixture is not particularly limited. However, blood which contains blood plasma and blood corpuscle may be named as the solid-liquid mixture, for example.

The above-mentioned invention is explained in conjunction with drawings. FIG. 1(a) is a perspective view with a part broken away showing one example of a device A having a solid-liquid separation function of the present invention. FIG. 1(b) is a view showing an essential part of a cross section taken along a line X-X in FIG. 1(a), and FIG. 1(c) is a view showing an essential part of a cross section taken along a line Y-Y in FIG. 1(a). That is, the device A having a solid-liquid separation function according to the present invention is constituted of a body 1 and a lid 100. The lid 100 is a lid which covers the whole surface of the body 1. In FIG. 1(a), the lid 100 is shown with a part broken away. Although the cross section taken along a line Y-Y in FIG. 1(a) is a cross section which divides the device A having a solid-liquid separation function into two equal parts in the lateral direction, the lid 100 is shown with a part broken away in FIG. 1(a) and hence, the cross section appears not to constitute the cross section of the lid 100. However, the cross section is the cross section which divides the device A having a solid-liquid separation function where the body 1 is covered with the lid 100 into two equal parts in the lateral direction.

A groove portion 2 which allows a fluid to pass therethrough is formed on a planar body 1. An inlet 3 for the fluid is formed on one end portion of the groove portion 2, and an outlet 4 is formed on the other end portion of the groove portion 2. The inlet 3 is an introducing port for introducing a solid-liquid mixture. A separation portion 5 which separates the mixture into solids and a liquid from each other by trapping the solids having a fixed size or larger is formed in the groove portion 2. The solid-liquid mixture is made to pass through the separation portion 5 toward a downstream from an upstream in the direction from an inlet side to an outlet side. The separation portion 5 is formed in a space between a bottom surface of the groove portion and a lower surface of the lid. On the bottom surface of the groove portion, a plurality of solid trapping portions 6, 6, 6 . . . which are formed of wall bodies extending in the direction perpendicular to the bottom surface and having distal ends thereof brought into contact with the lower surface of the lid 100 are formed. Parts indicated by symbols 10, 11 are passage through which a fluid passes. A width of a region of the separation portion 5 where the solid trapping portions 6 are formed (this region being equal to a region of the separation portion 5 in the case shown in the drawing) is narrow on a downstream side compared to on an upstream side.

A lid inlet 101 for introducing a solid-liquid mixture into the separation portion 5 and a lid outlet 102 for taking out the liquid from the separation portion 5 after separation are formed in a planar plate of the lid 100. The inlet 101 is arranged right above the inlet 3 formed in the body 1 and the lid outlet 102 is arranged right above the outlet 4 formed in the body 1, wherein the lid inlet 101 is communicated with the inlet 3 and the lid outlet 102 is communicated with the outlet 4. The separation efficiency can be improved by shortening a separation time, thus it is preferable that the wettability of one face and the wettability of the other face with respect to the liquid be close to each other in view of increasing the separation efficiency and hence, it is preferable to bring the surface of the lower surface of the lid into a state where the wettability of the surface is close to the wettability of the surface of the bottom surface of the lid.

FIG. 2 is a plan view showing a portion of the separation portion 5 in an enlarged manner and explaining a solid-liquid separation state. FIG. 2 schematically shows the separation portion 5 in a state where a lid body is removed. In the separation portion 5, the plurality of solid trapping portions 6, 6, 6 . . . are arranged in a space formed in a sandwiched manner between a bottom surface portion of the groove portion 2 which constitutes one face and a lower surface of the lid 100 which constitutes the other face facing the bottom surface portion in an opposed manner. The solid trapping portion 6 is formed of the bottom surface portion of the groove portion 2 and partition walls 61, 61 raised from the bottom surface substantially perpendicular to the bottom surface thus having a U shape in appearance. The solid trapping portion 6 includes an inlet portion 62 which is formed by the partition walls 61, an accommodating portion 63 which accommodates one or more solids 7 which enters the accommodating portion 63 through the inlet portion 62, and an opening portion 64 which is formed on a downstream side of the accommodating portion 63 and prevents a solid of a size equal to or larger than a size of the solid 7 from passing therethrough.

In performing solid-liquid separation, the solid-liquid mixture moves as indicated by arrows, the solid 7 having a fixed size or larger is trapped in the accommodating portion 63, and liquid is allowed to flow downwardly from the opening portion 64. In other words, the solid-liquid mixture flows through a space formed in a sandwiched manner between opposedly facing faces from the upstream, solid particles having a fixed size or larger are trapped by the solid trapping portions arranged in the space (because the downward flow of the solid particle is prevented by the opening portion 64 smaller than the solid 7), and only the liquid flows downward in the gap. Further, a volume of the solid particles which one solid trapping portion can trap is limited and hence, a large number of solid trapping portions are formed.

In FIG. 1(b), six pieces of solid trapping portions 6 are drawn. However, the drawing of the opening portion 64 which is to be seen at a center portion of each solid trapping portion 6 is omitted. Further, with respect to the solid trapping portions 6, only the solid trapping portions 6 which are seen on a frontmost row in cross section are drawn, and the solid trapping portions 6 on succeeding rows are not drawn. However, positions of the outlet 102 of the lid 100 and the outlet 4 of the body are indicated by a broken line. Further, in FIG. 1(c), seven pieces of solid trapping portions 6 are drawn. However, only the solid trapping portions 6 which are seen on a frontmost row in cross section are drawn, and the solid trapping portions 6 on succeeding rows are not drawn. Positions of the inlet 101 and the outlet 102 of the lid 100 and the inlet 3 and the outlet 4 of the body are accurately drawn.

Hereinafter, with respect to symbols used in the drawings for explaining the present invention, the same symbols are, in principle, used for parts having identical functions so long as confusion does not occur.

A shape of the above-mentioned solid trapping portion 6 is not limited to a U shape, and may take various shapes including a Y shape. The partition wall 61 of the solid trapping portion 6 may have various shapes including a shape where the opening portion 64 is formed on a wall body or rows of columnar bodies where the columnar bodies are arranged in row. Further, when the trapped solid 7 having a fixed size or larger closes off the opening portion 64, the flow of the fluid is stopped whereby the solid 7 having a fixed size or larger may refloat. Accordingly, it is preferable to provide the partition wall 61 where a plurality of opening portions 64 are formed therein as shown in FIG. 3(a), or the partition wall 61 where projections 65 are formed on an inner side of the partition wall 61 so as to avoid the solid 7 from closing off the opening portion as shown in FIG. 3(b). In FIG. 3, arrows indicate the moving direction of the fluid.

Further, FIG. 3(c) and FIG. 3(d) show examples of the solid trapping portions 6 which are formed of rows of columnar bodies where the columnar bodies are arranged in row. In FIG. 3(c) and FIG. 3(d), symbol 66 indicates columnar bodies, and a gap formed between the columnar bodies 66 forms the opening portion 64. FIG. 3(c) shows an example where the row of columnar bodies is arranged in a U shape, and FIG. 3(d) shows an example where the row of columnar bodies is arranged in a rectangular shape. In the solid trapping portion formed of the row of columnar bodies, a large number of opening portions 64 are formed and hence, a possibility that all opening portions are closed off by the solid having a fixed size or larger is low.

With respect to the size of the above-mentioned device, to take a case where the device is used as a device for obtaining blood plasmas by separating blood corpuscles from blood as an example, a trunk portion of the separation portion 5 has a longitudinal size of 0.1 to 10 mm and a lateral size of 0.1 to 10 mm, and a height of the solid trapping portion 6 in the separation portion 5 is approximately 4 to 100 μm.

In using such a device A, it is indispensable that a liquid in a solid-liquid mixture substantially continuously flows from the inlet to the outlet to an extent to prevent solids from refloating and flowing out from the trapping portion. As a propulsion force of this movement, the injection of a pressure from the inlet or suction from the outlet may be used. A moving speed of the solid-liquid mixture, in separating blood corpuscles from blood, is preferably set to a fixed speed so as to avoid the blood corpuscles from being deformed.

Further, in the device A, the reason the fluid is made to flow in the closed space formed between the opposedly facing faces is that a surface tension generated by wettability of the liquid with respect to the respective faces contributes to the propulsion force which advances the solid-liquid mixture to be separated. Further, also in moving the solid-liquid mixture by the injection of a pressure from the inlet or suction from the outlet, the formation of the closed space is necessary. Further, in treating blood as the solid-liquid mixture, it is preferable that the space be closed from a viewpoint of safety and hygiene.

In this manner, according to the device of the present invention, the separation portion 5 is arranged in the path through which the solid-liquid mixture moves. The floating solid 7 moves due to the flow of the liquid, the solid and the liquid enters the solid trapping portion 6 which is formed in the separation portion 5 through the inlet portion 62, and the solid 7 having a fixed size or larger is trapped in the accommodating portion 63 which can accommodate one or more solids which enter the accommodating portion 63 through the inlet portion 62. Then, the liquid which enters the accommodating portion 63 together with the solid 7 flows toward a downstream side through the opening portion 64 which is formed on a downstream side of the accommodating portion 63 and prevents the solid 7 having a fixed size or larger from passing therethrough. Accordingly, only the solid 7 having a fixed size or larger is trapped in the accommodating portion 63. For avoiding the refloating of the solid 7 having a fixed size or larger which is once trapped in the accommodating portion 63, it is necessary for the accommodating portion 63 to allow the liquid to continuously flow therethrough. For this end, it is preferable to take the structure which avoids the trapped solids from closing off the opening portion 64. As such structure, the structure where a curvature of the partition wall 61 of the accommodating portion 63 on the downstream side is set different from a curvature of the solid to be trapped, the structure where a plurality of opening portions 64 are formed on the partition wall 61, the structure where the projections 65 are formed on an inner side of the partition wall 61 and the like are preferably used.

The above-mentioned accommodating portion 63 accommodates one or a plurality of solids having a fixed size or larger. When the accommodating portion 63 is fully filled with the solids 7, the flow resistance of the accommodating portion fully filled with the solids 7 increases so that the solid-liquid does not enter such an accommodating portion and enters another accommodating portion by which the solid 7 having a fixed size or larger is trapped. In this case, it is necessary that all solids 7 having a fixed size or larger are completely trapped before the solids 7 reach a terminal end of the separation portion with the least flow resistance and with high separation efficiency. Accordingly, the arrangement of the solid trapping portions 6 in the separation portion becomes important.

According to the present invention, a width of a region of the separation portion 5 where the solid trapping portions 6 are formed is narrow on a downstream side compared to on an upstream side. Due to such a constitution, a larger number of solids can be trapped in the upstream portion having a large width and the solid-liquid mixture which contains the reduced number of solids is separated on the downstream side and hence, a large amount of liquid can be collected even when the width of the region of the separation portion where the solid trapping portions are formed is set narrow on a downstream side. On the other hand, in a conventional separation device where a region in which solid trapping portions are formed has a uniform width from an upstream side to a downstream side, when solids are trapped in an upstream portion having a narrow width compared to the upper portion of the present invention, a solid-liquid mixture which subsequently flows is liable to cause clogging so that the flow of a liquid toward the downstream side is decreased. Accordingly, the solid-liquid separation device according to the present invention can separate the solid-liquid mixture with high area efficiency and also with high liquid collection efficiency compared to the conventional solid-liquid separation device. Further, in the conventional solid-liquid separation device where the region of the separation portion in which the solid trapping portions are formed has a uniform width, for example, a converging portion 56 shown in FIG. 7 of patent document 1 is necessary for collecting liquid after separation into one place. According to the present invention, a width per se of the region of the separation portion where the solid trapping portions are formed is gradually narrowed toward a downstream side and hence, the separation portion has the above-mentioned liquid converging function whereby it is unnecessary to form the converging portion on the separation portion. Accordingly, the device becomes more compact so that an amount of wasteful liquid which adheres to and remains in the device after separation becomes smaller thus enhancing the liquid collection efficiency.

One example of the usage of the device A is explained with respect to a case where the device is used for obtaining blood plasmas from blood. A distal end of a syringe is mounted on the lid inlet 101 and blood in the syringe is injected into the lid inlet 101 using a piston. The blood is injected into the inlet 3 of the body from the lid inlet 101. Although an amount of blood to be injected depends on a size of the device, when a syringe is used, usually, it is sufficient that an amount of injected blood is approximately 0.1 to 1 μl. Further, it may be also possible to adopt a method where one drop of blood is dropped in the lid inlet 101 and a portion of the drop of the blood is made to pass through the passage 10 through the inlet 3 of the body and to reach the separation portion 5. In such a case, an amount of blood to be dropped is usually approximately 1 to 15 μl. Blood corpuscles in the injected blood are removed by the separation portion 5 and only blood plasmas are collected at the outlet 4. A reagent may be injected into the blood plasmas through a reagent introducing port and the blood plasma and the reagent may be mixed in a mixing portion (the reagent introducing port and the mixing portion not shown in the drawing). Blood plasmas may be taken out from the device for measuring a blood-sugar level, PH or the like. The measurement may also be performed by inserting electrodes or the like into the outlet 4. Also electrodes may be mounted on the outlet 4 in advance for detecting a blood-sugar level, PH or the like. Further, by forming the lid which covers the separation portion and/or the body using a transparent material, a transmitted light or a reflected light in the separation portion can be measured and hence, a blood corpuscles trapping state can be optically observed whereby a value expressed in terms of hematocrit value can be optically measured.

The device having a solid-liquid separation function of the present invention described in claim 2 is, in the device having a solid-liquid separation function described in claim 1, characterized in that the partition wall is formed of rows of columnar bodies or a wall body. The above-mentioned row of columnar bodies and the wall body are exactly as same as the row of columnar bodies and the wall body which are described in the explanation made in claim 1. Particularly, when the partition wall is formed of the row of columnar bodies, a large number of opening portions are formed in the solid trapping portion and hence, the possibility that all opening portions are closed off by solids having a fixed size or larger is decreased and hence, the separation of the solid-liquid mixture can be performed more easily.

The device having a solid-liquid separation function of the present invention described in claim 3 is, in the device having a solid-liquid separation function described in claim 1 or 2, characterized in that the partition wall is formed on the above-mentioned one face, and a material which forms the other face is a material softer than a material which forms the partition wall.

The device having a solid-liquid separation function of the present invention described in claim 4 is, in the device having a solid-liquid separation function described in claim 1 or 2, characterized in that the partition wall is formed on one face, and a material which forms the partition wall is a material softer than a material which forms the other face.

The device having a solid-liquid separation function of the present invention described in claim 5 is, in the device having a solid-liquid separation function described in claim 1 or 2, characterized in that the partition wall is formed on one face, and a buffer layer formed of a material softer than the material which forms the other face and the material which forms the partition wall is arranged between the partition wall and the other face.

The device having a solid-liquid separation function of the present invention described in claim 6 is, in the device having a solid-liquid separation function described in any one of claims 3 to 5, characterized in that the soft material is a resin having hardness of 10 to 100 based on a durometer scale.

The invention described in claim 3 to claim 6 is explained. In the device having a solid-liquid separation function according to the present invention, it is necessary that a gap formed between a distal end of the row of columnar bodies or the wall body, for example, which constitutes the partition wall and a face which faces the distal end in an opposed manner is set such that a solid particle to be separated is prevented from passing through the gap. For example, when the solid particle to be separated is a spherical body, it is necessary to set a size of the gap equal to or less than a diameter of the solid particle. When the solid particle is a circular disc, it is necessary to set a size of the gap equal to or less than a thickness of the circular plate. In view of the nature of the manufacturing of the device of this embodiment, an object on which the row of columnar bodies or the wall body which constitutes the separation wall is fixedly mounted and a counterpart object which faces the distal end of the row of columnar bodies or the wall body in an opposed manner are usually manufactured individually. Accordingly, in the manufacture of the device, it is desirable to assemble these objects while maintaining a proper gap formed between the objects such that the distal end of the row of columnar bodies or the wall body faces the counterpart object in an opposed manner. In the case where a minute solid is to be trapped and separated, it is particularly necessary to take into account the surface accuracy, that is, the planeness and the roughness of the surface of the object which faces the distal end of the row of columnar bodies or the wall body in an opposed manner. Accordingly, it is desirable that the counterpart object which faces the distal end of the row of columnar bodies or the wall body in an opposed manner has the structure which can absorb an error in size caused by shrinkage in a molding process or the like. In view of the above, it is desirable that a material which forms the other face is a material softer than a material which forms the partition wall. In the present invention, a material which forms the partition wall may be softer than a material which forms the other face, or a buffer layer which is a material softer than a material which forms the other face and a material which forms the partition wall may be interposed between the partition wall and the other face.

It is necessary to avoid the occurrence of a case that, at the time of assembling the device, a distal end of the row of columnar bodies or the wall body, for example, which constitutes the partition wall hits a face of a counterpart object and is broken so that the gap becomes excessively large. The row of columnar bodies or the wall body, for example, which constitutes the partition wall is configured to extend above an object which usually constitutes a bottom surface or the like and hence, the row of columnar bodies or the wall body, for example, which constitutes a partition wall or an object having these parts is preferably made of a material having softness. For example, when a hardening resin is used, it is preferable to use a resin which exhibits low hardness even after hardening. As an example of such a hardening resin, a dimethyl silicone resin is named.

On the other hand, in selecting materials, when the row of columnar bodies or the wall body, for example, which constitutes the partition wall is manufactured or when the row of columnar bodies or the wall body, for example, which constitutes the partition wall or an object having these parts is manufactured using a resin having high hardness, a face of the object which faces, in an opposed manner, the distal end of the row of columnar bodies or the wall body, for example, which constitutes the partition wall is, as a matter of course, preferably a material softer than a material which forms the partition wall.

In order to reduce the possibility that a distal end of the row of columnar bodies or the wall body, for example, which constitutes the partition wall hits a face of an opposedly facing object and is broken or to reduce the possibility that the distal end can be easily brought into close contact with the opposedly facing surface, a material for forming a face which faces, in an opposed manner, the object which constitutes the partition wall is preferably a resin having hardness of 10 to 100, preferably 10 to 60, and more preferably 20 to 50 based on a durometer scale. Further, in manufacturing the object which constitutes the partition wall using a resin having high hardness, it is preferable to form a coating film made of a material further softer than a material which forms the partition wall on a face of an object which faces, in an opposed manner, a distal end of the object which constitutes the partition wall or a film having a film thickness of several μm to several hundreds μm, preferably 4 μm to several tens μm is sandwiched between two objects.

Further, the object which faces, in an opposed manner, the distal end of the partition wall preferably has adhesiveness or slightly tacky adhesiveness. However, it is preferable that the object which faces, in an opposed manner, the distal end of the partition wall be non-adhesive to solids to be separated (for example, blood corpuscles).

The device having a solid-liquid separation function of the present invention described in claim 7 is, in the device having a solid-liquid separation function described in any one of claims 1 to 6, characterized in that a plurality of flow passages directed toward a downstream from an upstream are formed in the separation portion, the plurality of solid trapping portions which open toward the flow passages are arranged along the flow passages, one flow passage and another flow passage are defined from each other by a barrier wall or a barrier wall having an opening portion which prevents the solid having the fixed size or larger from passing therethrough.

The present invention described in claim 7 is explained in conjunction with drawings. FIG. 4 is a plan view schematically showing one example of one flow passage 9 used in the present invention. In the present invention, a plurality of such flow passages 9 are arranged in the separation portion. In FIG. 4, the flow passage 9 is defined from other flow passages by barrier walls 91. The barrier wall 91 may not have opening portions or may have opening portions which do not allow a solid having the above-mentioned fixed size or larger to pass therethrough. The barrier wall 91 prevents a solid having a fixed size or larger from passing therethrough, and the barrier wall 91 is preferably formed of either a wall body or rows of columnar bodies. FIG. 4 shows an example where the barrier wall 91 is formed of rows of columnar bodies consisting of columnar bodies 66 (in FIG. 4, to indicate that the barrier wall 91 is formed of the row of columnar bodies consisting of the columnar bodies 66, lead lines from a plurality of (4) columnar bodies 66 are depicted such that these lead lines are joined to one symbol 91). When the barrier wall 91 does not have opening portions, the movement of a liquid in a solid-liquid mixture does not occur between one flow passage and another flow passage which is arranged adjacent to one flow passage. However, when the barrier wall 91 has opening portions which do not allow a solid having the above-mentioned fixed size or larger to pass therethrough, the movement of the liquid in the solid-liquid mixture occurs between one flow passage and another flow passage arranged adjacent to one flow passage. In both cases, no movement of a solid larger than the above-mentioned opening portion occurs between one flow passage and another flow passage arranged adjacent to one flow passage.

To take a case where the barrier wall 91 is formed of rows of columnar bodies and this device is used as a device for acquiring blood plasmas by separating red corpuscles from blood as an example, the red corpuscle has a disk-like shape of a thickness of approximately 2.5 μm and a diameter of approximately 8 μm and hence, a distance between the columnar bodies (inner size) is preferably set to 0.8 to 2 μm and a height of the columnar body is preferably set to approximately 10 μm.

Further, the plurality of solid trapping portions 6 which open toward the flow passage 9 are arranged along the flow passage 9. In this case, in the solid trapping portion 6 arranged along the flow passage 6, the opening for trapping a solid is preferably directed to an upstream of the flow passage 9 or a approximate direction of upstream for enhancing solid trapping efficiency. FIG. 4 shows an example of the solid trapping portion 6 where the partition wall is formed of rows of columnar bodies consisting of the columnar bodies 66. However, the solid trapping portion 6 may be formed of the wall body shown in FIG. 2, FIG. 3(a) or FIG. 3(b).

Next, a process of introducing a solid-liquid mixture into the flow passage 9 and separating the solid-liquid mixture into solids and a liquid is explained. The solid-liquid mixture enters the flow passage 9 through a flow passage inlet 92, and the liquid flows in the right downward direction shown in the drawing, while the solids advance in a zigzag shape along paths indicated by a by receiving obstruction. Then, at positions where an opening of the solid trapping portion 6 is arranged directly facing against the advancing direction, some solids advance in the direction b or in the direction c indicated in the drawing and enter the solid trapping portions 6, and the solid 7 having a fixed size or larger is trapped in the accommodating portion. The liquid which enters the accommodating portion together with the solids flows toward a downstream side through the opening portion which is provided on a downstream side of the accommodating portion, and does not allow the solids having a fixed size or larger to pass therethrough. Accordingly, only the solids having a fixed size or larger are trapped in the accommodating portion.

To prevent the solid having a fixed size or larger which is once trapped from refloating, it is necessary that the liquid continuously flows in the accommodating portion. In the case where the accommodating portion is already fully filled with the solids as some of solid-liquid mixture enters the solid trapping portion, then, when the flow resistance in the accommodating portion filled with the solids is increased so that the mixture do not enter such an accommodating portion or it becomes difficult for the solids and the liquid to enter such an accommodating portion whereby the solids and the liquid advance in a zigzag manner along the flow passage. Then, at a position where the opening of the solid trapping portion 6 is formed on a more downstream side directly facing against the advancing direction, some of the solid-liquid mixture advances in the direction b or in the direction c and enters the solid trapping portion 6, the solid 7 is trapped in the accommodating portion, and the liquid which enters the accommodating portion together with the solid flows toward a downstream side through the opening portion which is provided on a downstream side of the accommodating portion and does not allow the solid having a fixed size or larger to pass therethrough.

By repeating such a step, the solids are separated from the solid-liquid mixture so that through the flow passage outlet 93 of the flow passage, only liquid (and solids having a size smaller than a size of the opening portion formed on a downstream side of the accommodating portion when such solids are contained in the solid-liquid mixture to be separated) flows out. The liquid which is discharged from the down-stream-side opening portion of the accommodating portion of the solid trapping portion 6 merges with a liquid which flows out from other portions and a merged liquid flows in the direction toward an exit. The arrangement of the solid trapping portions 6 is not limited and, to increase area efficiency, it is preferable that the solid trapping portions 6 be regularly arranged on both sides of the flow passage, and it is also preferable that the solid trapping portions 6 be arranged adjacent to each other.

In the device having a solid-liquid separation function according to the present invention, a plurality of such flow passages 9 are formed in the separation portion. Further, a width of a region of the separation portion where the solid trapping portions are formed is narrow on a downstream side compared to on an upstream side. FIG. 5 is a plan view of the device B on a body side of the device having such a solid-liquid separation function (an actual device having a solid-liquid separation function is constituted of the device B on a body side and the lid shown in FIG. 1, for example). In this device B, a groove portion 2 which allows the fluid to pass therethrough is formed on a body 1 having a planar shape, and the groove portion 2 is constituted of a fluid inlet 3, a separation portion 5, an outlet 4, and passages 10, 11. The separation portion 5 is formed of a trunk portion 54 in which a large number of solid trapping portions consisting of rows of columnar bodies 66 are arranged. (The rows of columnar bodies 66 arranged in the trunk portion 54 are schematically depicted and do not represent the actual row of columnar bodies 66. Accordingly, FIG. 5 does not also clearly show the solid trapping portions consisting of these rows of columnar bodies 66. The actual rows of columnar bodies 66 are shown in FIG. 6 described later.) Besides these parts, it is desirable that the device includes a solid-liquid mixture dispersing portion 51 for dispersing a solid-liquid mixture fed from the passage 10, and a final trapping portion 55 which does not allow solids having a fixed size or larger which reaches the final trapping portion 55 as a result that the solid cannot be trapped by the trunk portion 54 by chance to pass therethrough.

The solid-liquid mixture dispersing portion 51 is a space having a triangular shape in horizontal cross section, and a large number of columnar obstruction bodies 52 having a rhombic shape in horizontal cross section are formed therein.

The trunk portion 54 is the space having a triangular shape in horizontal cross section, and as can be understood from FIG. 6 which shows a portion where the trunk portion and the final trapping portion in FIG. 5 are positioned in an enlarged manner, a large number of solid trapping portions 6, 6, 6 . . . each of which is constituted of the columnar bodies 66, 66, 66 . . . are formed in the trunk portion 54. The final trapping portion 55 is a space having a trapezoidal shape in horizontal cross section, and as can be understood from FIG. 6, rows of columnar bodies where a distance between the columnar bodies is set smaller than a size of a solid to be trapped such that the columnar bodies do not allow the solid to be trapped to pass through the gap formed between the columnar bodies are formed. In FIG. 6, a solid-liquid mixture to be separated flows in the direction indicated by arrows. In FIG. 6, a region of the separation portion where the solid trapping portions are formed according to the present invention indicates the trunk portion 54.

Further, although FIG. 5 does not clearly show, a depth of the inlet 3, a depth of the solid-liquid mixture dispersing portion 51 in the separation portion 5, a depth of the outlet 4 and depths of passages 10, 11 are set larger than a depth of the trunk portion 54 and a depth of the final trapping portion 55 in the separation portion 5.

In the above-mentioned setting of the depths of the respective parts, the reason that the passage 10 which connects the inlet 3 and the separation portion 5 and the solid-liquid mixture dispersing portion 51 in the separation portion 5 are set deep and the trunk portion 54 in the separation portion 5 is set shallow is as follows. To acquire the smooth flow and to avoid the increase of the flow passage resistance in making a viscous liquid containing solids flow in the passage 10, the passage 10 requires a proper passage cross-sectional area. For example, a passage width and a passage depth may be set to 100 μm and 30 μm respectively. On the other hand, the trunk portion 54 in the separation portion 5 mainly aims at the separation of solids (for example, red corpuscles) and hence, a depth of the barrel portion 54 is set shallow, that is, 10 μm, for example, and a width of the trunk portion is enlarged depending on a use purpose. For this end, it may be possible to adopt the structure where the flow passage is made deep thus lowering the flow passage resistance immediately before the trunk portion of the separation portion, and the flow passage is made shallow in the trunk portion.

It is preferable that the device having a solid-liquid separation function according to the present invention described in claim 7 also have the substantially same technical features as the device having a solid-liquid separation function of the present invention described in claim 1.

That is, it is preferable that the solid trapping portion and the barrier wall be constituted of rows of columnar bodies. The solid trapping portion and the barrier wall which are constituted of rows of columnar bodies are exactly as same as the corresponding portions described in the explanation of claim 7. A large number of opening portions are formed in the solid trapping portion and the barrier wall constituted of rows of columnar bodies and hence, a possibility that all opening portions are closed off by solids having a fixed size or larger becomes low and hence, the separation of the solid-liquid mixture can be performed more easily.

Further, it is preferable that the solid trapping portion and the barrier wall be formed on one face, and a material which forms the other face is a material softer than a material which forms the solid trapping portion or the barrier wall.

Further, it is preferable that the material which forms the other face be a resin having a hardness of 10 to 100 based on a durometer scale.

The above-mentioned technical features are explained hereinafter.

In the device having a solid-liquid separation function according to the present invention, it is required that a gap formed between a distal end of the row of columnar bodies or the wall body, for example, which constitutes the solid trapping portions and the barrier wall and a face which faces the distal end in an opposed manner is set such that a solid particle to be separated is prevented from passing through the gap. In view of the nature of the manufacturing of the device of this embodiment, an object on which the row of columnar bodies or the wall body which constitutes the solid trapping portions and the barrier wall is fixedly mounted and a counterpart object which faces the distal end of the row of columnar bodies or the wall body in an opposed manner are usually manufactured individually. Accordingly, in the manufacture of the device, it is desirable to assemble these objects while maintaining a proper gap formed between the objects such that the distal end of the row of columnar bodies or the wall body faces the counterpart object in an opposed manner. In the case where a minute solid is to be trapped and separated, it is particularly necessary to take into account the surface accuracy, that is, the planeness and the surface roughness of the face of the object which faces the distal end of the row of columnar bodies or the wall body in an opposed manner. Accordingly, it is desirable that the counterpart object which faces the distal end of the row of columnar bodies or the wall body in an opposed manner has the structure which can absorb an error in size caused by shrinkage in molding process or the like. In view of the above, it is desirable that a material which forms the other face is a material softer than a material which forms the solid trapping portions and the barrier wall.

It is necessary to avoid a case where, at the time of assembling the device, a distal end of the row of columnar bodies or the wall body, for example, which constitutes the solid trapping portions or the barrier wall hits a face of a counterpart object and is broken, or a case where the gap becomes excessively large. The row of columnar bodies or the wall body, for example, which constitutes the solid trapping portions and the barrier wall is configured to extend above an object which usually constitutes a bottom surface or the like and hence, the row of columnar bodies or the wall body, for example, which constitutes the solid trapping portions and the barrier wall or an object having these parts is preferably a material having softness. For example, when a hardening resin is used, it is preferable to use a resin which exhibits low hardness even after hardening. As an example of such a hardening resin, a polydimethylsiloxane (PDMS) is named.

On the other hand, in selecting materials, when the row of columnar bodies or the wall body, for example, which constitutes the solid trapping portions and the barrier wall is manufactured or when the row of columnar bodies or the wall body, for example, which constitutes the solid trapping portions and the barrier wall or an object having these parts is manufactured using a resin having high hardness, a face of the object which faces, in an opposed manner, the distal end of the row of columnar bodies or the wall body, for example, which constitutes the solid trapping portions and the barrier wall is, as a matter of course, preferably a material softer than a material which forms the columnar bodies or the wall body.

Due to reasons that a possibility that a distal end of the row of columnar bodies or the wall body, for example, which constitutes the solid trapping portions and the barrier wall hits a face of an opposedly facing object and is broken must be lowered and the distal end can be easily brought into close contact with the opposedly facing surface, a material which forms a face which faces, in an opposed manner, the object which constitutes the solid trapping portions and the barrier wall is preferably a resin having hardness of 10 to 100, preferably 10 to 60, and more preferably 20 to 50 based on a durometer scale. Further, in manufacturing the row of columnar bodies or the wall body which constitutes the solid trapping portions and the barrier wall or the object having these parts using a resin having high hardness, it is preferable to form a coating film made of a material further softer than a material which forms the row of columnar bodies or the wall body on a face of the object which faces, in an opposed manner, the distal end of the row of columnar bodies or the wall body or a film having a film thickness of several μm to several hundreds μm, preferably 4 μm to several tens μm is sandwiched between two objects.

Further, the object which faces, in an opposed manner, the distal end of the row of columnar bodies or the wall body, for example, which constitutes the solid trapping portions and the barrier wall preferably has adhesiveness or slightly tacky adhesiveness. However, it is preferable that the object which faces, in an opposed manner, the distal end of the row of columnar bodies or the wall body be non-adhesive to solids to be separated (for example, blood corpuscles).

Although a method of manufacturing the device having a solid-liquid separation function according to the present invention is not limited, for example, a method which uses a photolithography process described in patent document 1 as a part of the manufacturing step is named.

For example, the manufacture by the device B by a photolithography process is explained in conjunction with FIG. 7 by taking a case where the device B on a body side of the device having a solid-liquid separation function shown in FIG. 5 and FIG. 6 is manufactured as an example. The explanations 1, 2, 3, 4 and 5 at a center portion in FIG. 7 describe steps taken in manufacturing the device of the present invention. Schematic cross-sectional views (cross-sectional views taken along a line E-E in FIG. 5) which show the passage 10 and a state in the vicinity of the passage 10 in the above-mentioned respective steps are arranged on a right side in the drawing, and schematic cross-sectional views (cross-sectional views taken along a line F-F in FIG. 5) which show the trunk portion 54 of the separation portion 5 and a state in the vicinity of the trunk portion 54 in the above-mentioned respective steps are arranged on a left side in the drawing. With respect to the schematic cross-sectional views which show the passage 10 and the state in the vicinity of the passage 10, although names of respective layers are not shown, the names of the respective layers are the same as the corresponding names described in the schematic cross-sectional views showing the trunk portion 54 of the separation portion 5 and the state in the vicinity of the trunk portion 54.

Step 1 is a resist coating step where a first photoresist layer is formed by coating on a glass substrate. Due to this step, as shown in FIG. 7, the first photoresist layer is laminated to the whole glass substrate including the passage 10 and the trunk portion 54 of the separation portion 5.

Step 2 is an exposure step 1. This step is a step where exposure is performed while masking the inlet 3, portions in the separation portion 5 except for rhombic columnar obstruction bodies 52 of the solid-liquid mixture diffusing part 51, the outlet 4 and the passages 10, 11. A UV light is irradiated onto the first photoresist layer in a state where a photo mask which shields only the above-mentioned portions from the irradiation of UV light is placed on the first photoresist layer. Due to this step, portions other than the above-mentioned portions are exposed. As shown in FIG. 7, the exposure is performed in a state where the passage 10 is shielded from the UV light by masking so that the passage 10 is not exposed, and a body portion outside the passage 10 is exposed. Further, the exposure is performed in a state where the trunk portion 54 of the separation portion 5 is not shielded from the UV light by masking so that the trunk portion 54 is exposed.

Step 3 is a step where a second photoresist layer is formed by coating on the first photoresist layer. Due to this step, as shown in FIG. 7, the second photoresist layer is laminated to the whole layer where the first photoresist layer is laminated including the passage 10 and the trunk portion 54 of the separation portion 5.

Step 4 is an exposure step 2. This step is a step where exposure is performed while masking the inlet 3, portions in the solid-liquid mixture diffusing part 51 of the separation portion 5 except for columnar obstruction bodies 52, portions in the trunk portion 54 of the separation portion 5 except for the row of columnar bodies, portions in the final trapping portions 55 of the separation portion 5 except for the row of columnar bodies, the outlet 4 and the passages 10, 11. A UV light is irradiated onto the second photoresist layer in a state where a photo mask which shields only the above-mentioned portions from the irradiation of light is placed on the second photoresist layer. Due to this step, portions other than the above-mentioned portions are exposed. As shown in FIG. 7, the exposure is performed in a state where the passage 10 is shielded from the UV light by masking so that the passage 10 is not exposed, and a body portion outside the passage 10 is exposed. The exposure is performed in a state where portions of the trunk portion 54 of the separation portion 5 except for the row of columnar bodies are shielded from a UV light by masking. Accordingly, portions other than the portions shielded from the UV light by masking, that is, the row of columnar bodies is exposed.

Step 5 is a developing step. The photoresist layer at the portions shielded from the UV light by masking is dissolved by developing. Due to this step, the device B on a body side of the device having a solid-liquid separation function shown in FIG. 5 is obtained. As shown in FIG. 7, the passage 10 which uses the glass substrate as an inner bottom surface is formed in the body portion which is constituted of a hardened material formed by laminating the first photoresist layer and the second photoresist layer. In the trunk portion 54 of the separation portion 5, on the hardened material forming the first photoresist layer, the row of columnar bodies constituted of the hard material forming the second photoresist layer is formed. Outside the trunk portion 54, the body portion which is constituted of the hardened material formed by laminating the first photoresist layer and the second photoresist layer is formed.

As another manufacturing method, a body can be manufactured such that an object having a shape of the body is formed by photolithography, the object per se or the object to which electroless plating is further applied using nickel phosphor or the like is used as a mold, uncured monomer, oligomer, resin or the like in a liquid form is filled into the mold, and the filled material is cured with heat, radiation rays or the like thus preparing the body. Further, the body can be also manufactured by injection molding using a thermoplastic resin.

On the other hand, the body can also be manufactured as follows. Using an LIGA (Lithographie Galvanoformung Abformung) method where a metal mold material is directly subject to electro casting by a lithography method, a mold having deep holes with high aspect ratio for forming columns of rows of columns, for example, is directly manufactured. Then, uncured monomer, oligomer, resin or the like is filled into the mold, and the filled material is cured with heat, radiation rays or the like, and a body is prepared by taking out a cured object. Using the LIGA method, a pattern is transferred to a resist (photosensitive organic material) having a thickness of 100 μm or larger by way of an X-ray mask using X-rays generated from a synchrotron radiation (SR) beam device having favorable straight advancing property so that an ultra precision part having a desired shape in the lateral direction with a depth (height) of 100 μm or larger can be manufactured. Further, the body can be manufactured also by injection molding using a thermoplastic resin. By adopting such a method, the body can be manufactured with high mass productivity so that the method is preferable.

The lid can be manufactured by injection molding or the like using a thermoplastic resin.

The device having a solid separation function described in claim 8 is, in the device having a solid-liquid separation function described in any one of claims 1 to 7, characterized in that the separation portion in which the width of the region where the solid trapping portions are formed is narrow on the downstream side compared to the upstream side is provided in plural on one plane, and liquids from the plurality of separation portions are merged.

The device having a solid separation function described in claim 9 is, in the device having a solid-liquid separation function described in any one of claims 1 to 8, characterized in that the plurality of separation portions in which the width of the region where the solid trapping portions are formed is narrow on the downstream side compared to the upstream side are gathered thus forming a circular shape or an arcuate shape, and a discharge opening for a merged liquid formed of liquids from the plurality of separation portions is formed at a center portion of a circle or an arc.

FIG. 8(a) to FIG. 8(e) are plan views each of which is provided for explaining an example of a plurality of separation portions 5, 5 . . . where a width of a region of the separation portion 5, 5 . . . in which the solid trapping portions are formed is narrow on a downstream side compared to on an upstream side, partition portions 56, 56 . . . each of which is arranged between each two of the plurality of separation portions 5, 5 . . . , and a merging portion 57 where liquids from the plurality of separation portions 5, 5 . . . are merged in the present invention described in claim 8 or 9. In the respective separation portions 5 shown in FIG. 8(a) to FIG. 8(e), although a large number of solid trapping portions are provided in the separation portion 5 in an actual constitution, these solid trapping portions are omitted from the drawing. The respective separation portions 5, 5 . . . are defined by the partition portions 56, 56 . . . . As shown in FIG. 8(a), a vacant space may exist between the partition portions 56, 56 . . . which partition the neighboring separation portions 5, 5 . . . . Further, as shown in FIG. 8(b), FIG. 8(c), FIG. 8(d) and FIG. 8(e), the neighboring separation portions 5, 5 . . . may be defined by the partition portion 56, 56 . . . shared in common.

As shown in FIG. 8 (a), when the vacant space exists between the neighboring separation portions, there is a possibility that the strength of the device is lowered. In such a case, the strength of the device may be increased by filling the vacant space with a predetermined reinforcing material. Further, it is also possible to impart a function other than the separation function such as a reservoir, for example, to the portion filled with the reinforcing material. When the separation portions are defined by the partition portion 56, 56 . . . shared in common, it is possible to obtain an advantage that the device becomes more compact. In other words, by arranging the separation portions adjacent to each other, it is possible to obtain favorable area efficiency in the separation and hence, the above-mentioned constitution is preferable also from a viewpoint of strength.

Although a planar shape of the whole device formed of the respective separation portions 5, 5 . . . and the respective partition portions 56, 56 is not particularly limited, a circular shape, an arcuate shape, and a polygonal shape can be named, for example. It is preferable that a time during which a solid-liquid mixture flows in the separation portion and a separated liquid arrives at the merging portion be equal with respect to all separation portions. Accordingly, when a polygonal shape is adopted as the planar shape of the whole device, a regular polygonal shape is preferable. Further, the number of sides is not limited. Accordingly, the planar shape of the device is not limited to a regular octagonal shape shown in FIG. 8(c), for example, and the planar shape of the device maybe a regular quadrangular shape, a regular pentagonal shape, a regular hexagonal shape, a regular heptagonal shape . . . or the like.

As an example of the above-mentioned circular shape which the device has, the shape shown in FIG. 8(b) can be named. As an example of the device having an arcuate shape described above, the device having an elliptical shape shown in FIG. 8(d) and the device having a shape similar to a shape of a running track shown in FIG. 8(e) can be named. The use of the circular-shaped device or the arc-shaped device is particularly preferable due to the following reasons. The devices can acquire the following advantageous effect besides an advantageous effect that a time during which a solid-liquid mixture flows in the separation portion and arrives at the merging portion is approximately equal among all separation portions. That is, the circular-shaped device and the arc-shaped device receive a dynamic external force during the manufacture of the devices, in the course of the distribution of the devices or at the time of assembling or disassembling the device on or from a μ-TAS or the like. In such operations, however, the device has the structure where the local concentration of a stress hardly occurs so that the device is hardly broken and leakage of a liquid hardly occurs at the time of incorporating the device into the

A shape of the merging portion 57 where liquids from the plurality of separation portions are merged is not particularly limited, and a circular shape, a polygonal shape or the like can be named, for example.

In merging liquids from the plurality of separation portions, by setting separation states of the respective separation portions similar to each other, a liquid acquired by merging can be made uniform more easily. Accordingly, it is preferable that the respective separation portions have the similar structures.

The plurality of separation portions in each of which a width of the region where the solid trapping portions are formed is narrow on a downstream side compared to on an upstream side are put together thus forming the structure having a circular shape or an arcuate shape, and the discharge opening for a merged liquid formed of liquids from the plurality of separation portions is formed at the center portion of the structure having a circular shape or an arcuate shape. Due to such a constitution, the device can be made more compact and hence, the constitution is particularly preferable.

### Advantageous Effect of the Invention

According to the invention described in claim 1, by just causing a solid-liquid mixture to flow into the passage, solids are carried away by an energized flow of the liquid, only solids having a fixed size or larger are trapped in the midst of the passage, and the liquid and the solids smaller than a predetermined size reach the outlet so that a rate of the obtained liquid with respect to the solid-liquid mixture flown into the passage is high. In this manner, electric field is unnecessary and hence, electrodes and a voltage source become unnecessary whereby the device can be miniaturized, and can be easily manufactured at a low cost. Further, the separation of solids from a liquid can be performed in a short time.

A width of the region of the separation portion where the solid trapping portions are formed is narrow on a downstream side compared to on an upstream side and hence, a larger number of solids can be trapped in the upstream portion having a large width and the solid-liquid mixture which contains the reduced number of solids is separated on the downstream side whereby a large amount of liquid can be collected even when the width of the region of the separation portion where the solid trapping portions are formed is set narrow on the downstream side compared to the upstream side. On the other hand, in a conventional separation device where a region in which solid trapping portions are formed has a uniform width from an upstream side to a downstream side, when solids are trapped in an upstream portion having a narrow width compared to the upper portion of the present invention, a solid-liquid mixture which subsequently flows is liable to cause clogging so that the flow of a liquid toward the downstream side is decreased.

Accordingly, the solid-liquid separation device according to the present invention can separate the solid-liquid mixture with high area efficiency and also with a high liquid collection efficiency compared to the conventional solid-liquid separation device. Further, in the conventional solid-liquid separation device where the region of the separation portion in which the solid trapping portions are formed has a uniform width, for example, a converging portion 56 shown in FIG. 7 of patent document 1 is necessary for collecting liquid after separation into one outlet. According to the present invention, a width per se of the region of the separation portion where the solid trapping portions are formed is gradually narrowed toward a downstream side and hence, the separation portion has the above-mentioned liquid converging function whereby it is unnecessary to form the converging portion on the separation portion. Accordingly, the device becomes more compact so that an amount of wasteful liquid which adheres to and remains in the device after separation becomes smaller thus enhancing the liquid collection efficiency.

The invention descried in claim 2 acquires the substantially same advantageous effects as the invention described in claim 1. Particularly, when the partition wall is formed of the row of columnar bodies, a large number of opening portions are formed in the solid trapping portion and hence, the possibility that all opening portions are closed off by solids having a fixed size or larger is decreased whereby the separation of the solid-liquid mixture can be performed more easily.

The inventions descried in claims 3 to 6 acquire an advantageous effect that even when the gap becomes smaller than a predetermined gap due to an error in size during or after an assembling of the device, a possibility that distal ends of the row of columnar bodies or the wall body, for example, which constitutes the partition wall are brought into contact with and broken by a face of a counterpart object becomes low, and the distal ends are more easily brought into close contact with the opposedly facing face.

The invention descried in claim 4 also acquires an advantageous effect that when the partition wall structure is prepared by a stamping method, an operation of removing the partition wall structure from a mold can be performed smoothly with a high yield.

The invention descried in claim 7 acquires the substantially same advantageous effects as the invention described in any one of claims 1 to 6. Particularly when the flow passage is formed by the row of columnar bodies, a large number of opening portions are formed in the flow passage and hence, a possibility that all opening portions are closed off by solids having a fixed size or larger becomes low and hence, the separation of the solid-liquid mixture can be performed more easily.

The invention descried in claim 8 acquires the substantially same advantageous effects as the invention described in any one of claims 1 to 7. Further, liquids from the plurality of separation portions are merged and hence, a larger amount of liquid can be obtained at a time whereby the processing such as an analysis of the obtained liquid can be performed more efficiently.

The invention descried in claim 9 acquires the substantially same advantageous effects as the invention described in any one of claims 1 to 8. Further, the plurality of separation portions in which the width of the region where the solid trapping portions are formed is narrow on the downstream side compared to the upstream side are gathered thus forming a circular shape or an arcuate shape, and a discharge opening for a merged liquid formed of liquids from the plurality of separation portions is formed at a center portion of a circle or an arc. Accordingly, an area efficiency of the device at the time of separation is further improved and hence, the device can be made more compact and more miniaturized. Further, the liquid can be collected more efficiently. Still further, by connecting a device for analyzing the obtained liquid to a discharge opening for the merged liquid, the liquid can be analyzed more efficiently.

The invention descried in claim 10 acquires the substantially same advantageous effects as any one of the invention described in claims 1 to 9, and also acquires the complete separation of a solid-liquid mixture in the separation portion.

According to the invention descried in claim 11, it is difficult for a solid having a heterogeneous shape (for example, red corpuscle) to take a posture where the longitudinal direction of the sold is directed in the direction along the gap and hence, it is possible to prevent the solid from passing through the opening portion formed in the partition wall or the gap between the columnar bodies whereby the further complete separation of the solid-liquid mixture can be achieved in the separation portion.

According to the invention descried in claim 12, it is possible to provide the μ-TAS having a filtering function which can obtain a larger amount of liquid from which solids are separated more efficiently.

According to the invention descried in claim 13, it is possible to avoid the occurrence of a state where a solid separated from a solid-liquid mixture causes clogging in the separation portion as much as possible.

### BRIEF DESCRIPTION OF THE DRAWINGS

FIG. 1(a) is a perspective view with a part broken away showing one example of a device A having a solid-liquid separation function according to the present invention, FIG. 1(b) is a cross-sectional view of an essential part taken along a line X-X in FIG. 1(a), and FIG. 1(c) is a cross-sectional view of an essential part taken along a line Y-Y in FIG. 1(a).

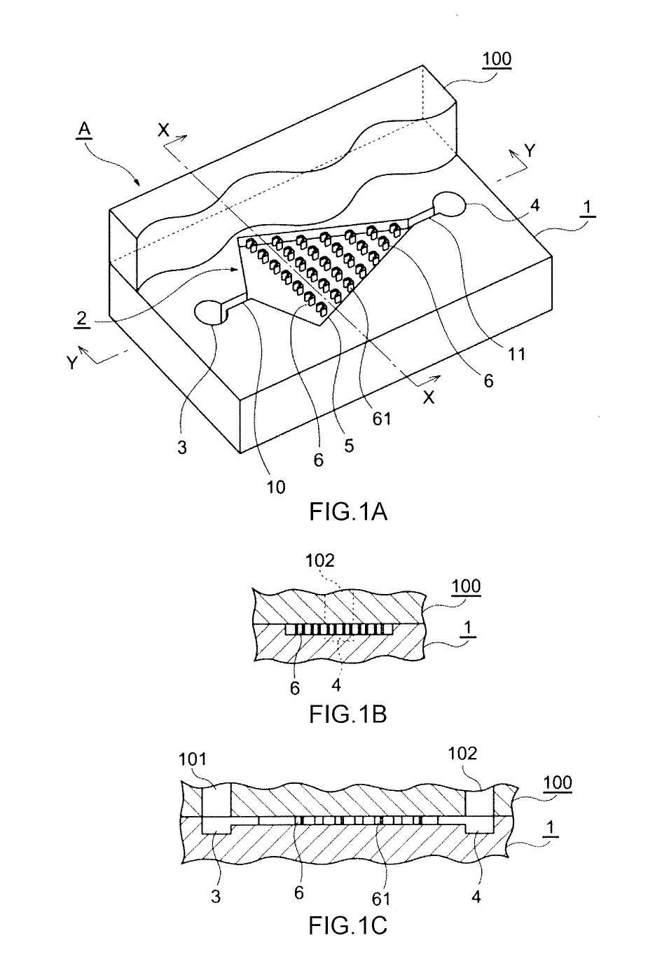

FIG. 2 is a plan view showing a portion of a separation portion in an enlarged manner and explaining a state of solid-liquid separation, and is also a view schematically showing a state where a lid body is removed.

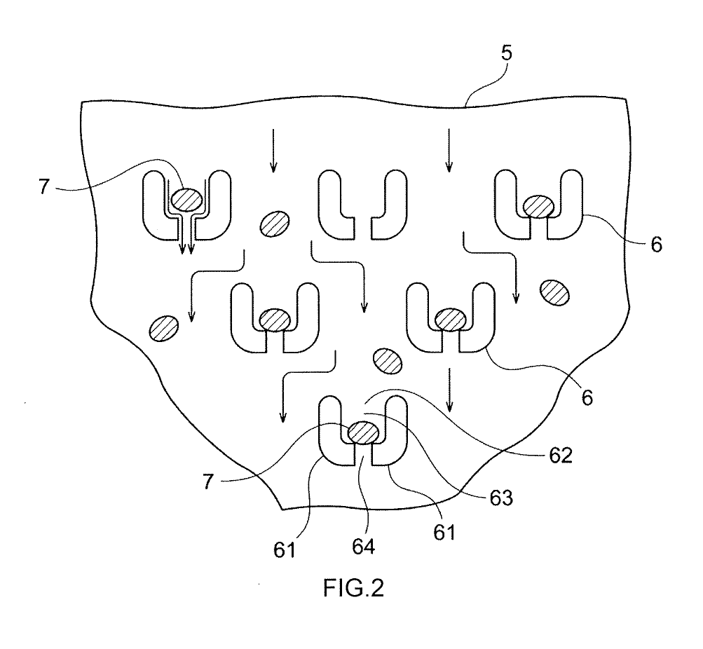

FIG. 3 is a plan view showing an example of a solid trapping portion.

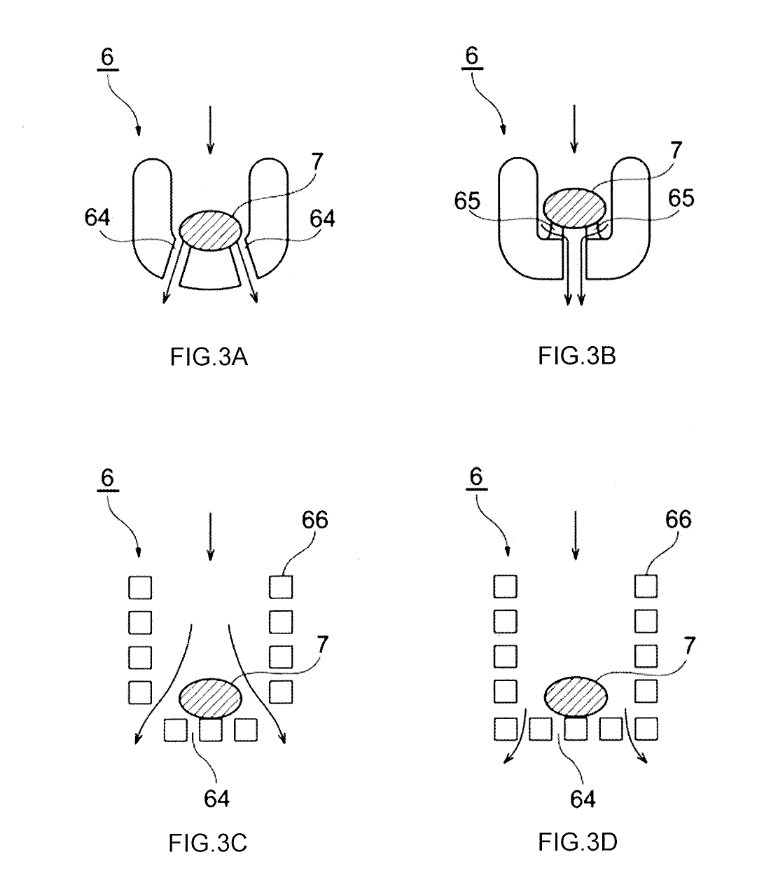

FIG. 4 is a plan view schematically showing one example of one flow passage used in the present invention.

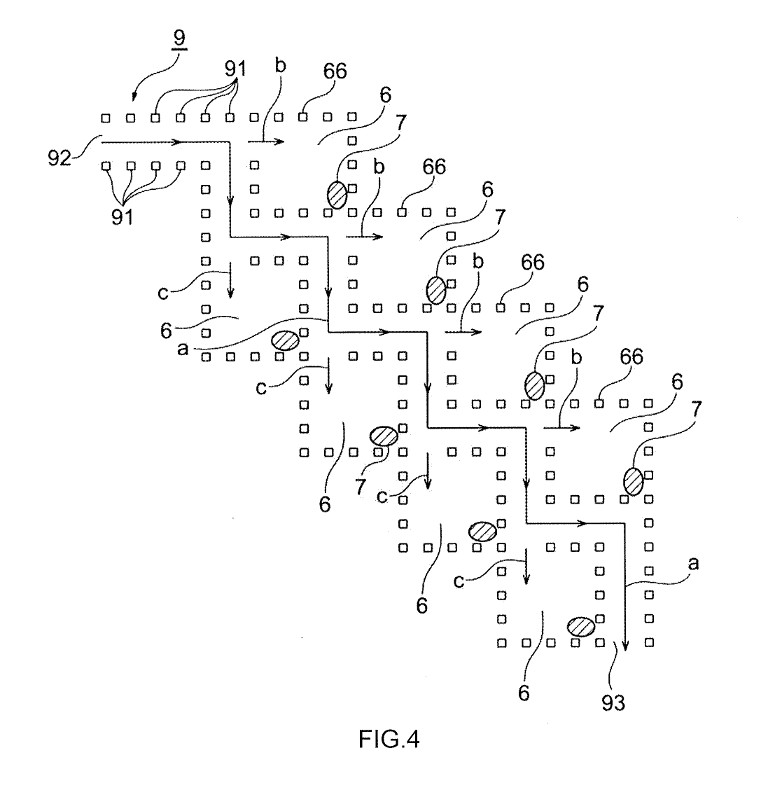

FIG. 5 is a plan view showing one example of a device on a body side of the device having a solid-liquid separation function according to the present invention.

FIG. 6 is a view showing a portion in FIG. 5 where a trunk portion and a final trapping portion are positioned in an enlarged manner.

FIG. 7 is a cross-sectional view for explaining one example of a manufacturing method of the device having a solid-liquid separation function.

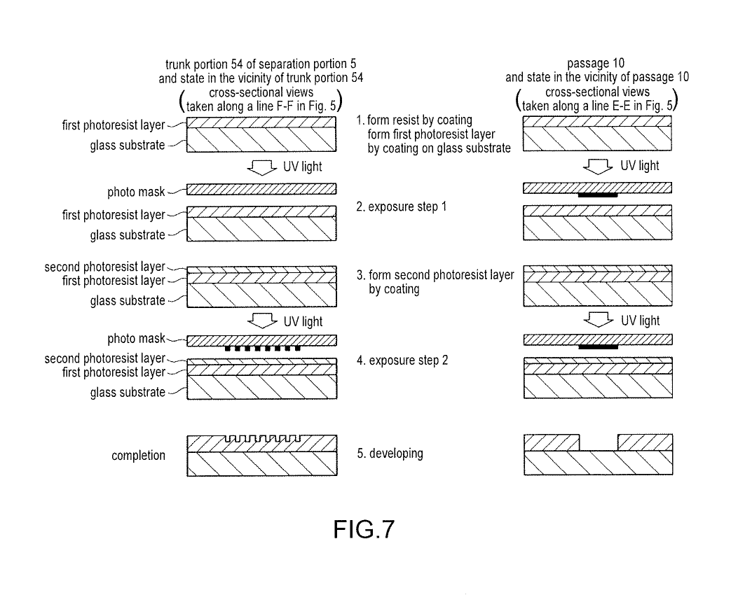

FIG. 8(a) to FIG. 8(e) are plan views each of which is provided for explaining an example of a plurality of separation portions where a width of a region of the separation portion where the solid trapping portions are formed is narrow on a downstream side compared to on an upstream side, partition portions each of which is arranged between each two of the plurality of separation portions, and a merging portion where liquids from the plurality of separation portions are merged.

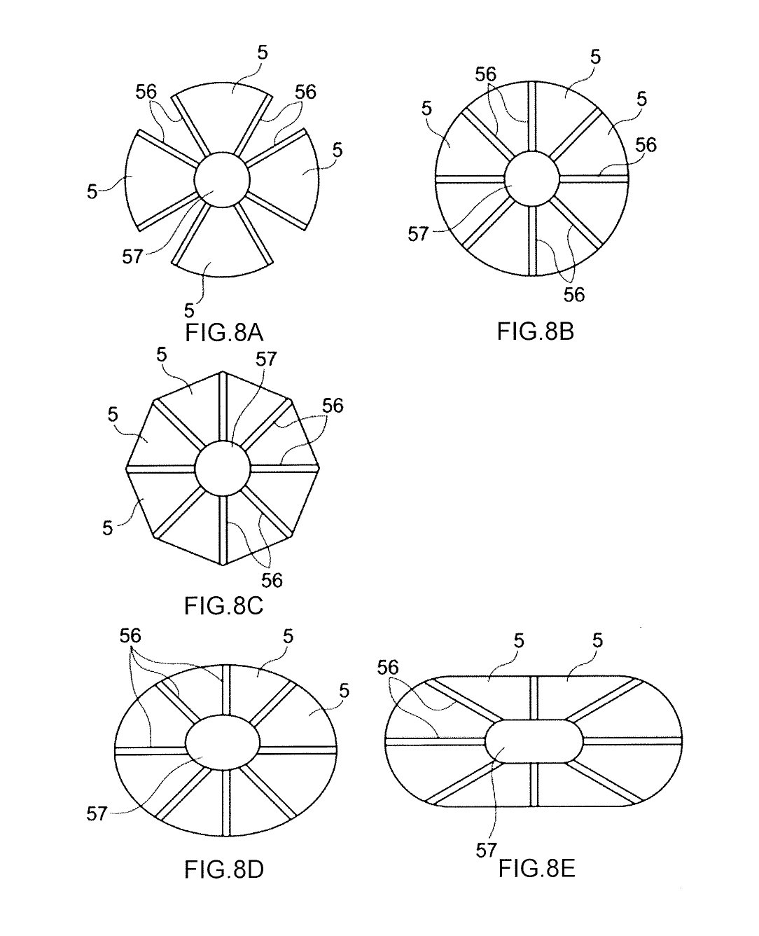

FIG. 9(a) is a plan view of a μ-TAS device body in which a device C having a solid-liquid separation function is incorporated, and FIG. 9(b) is a cross-sectional view of the μ-TAS device body taken along a line G-G in FIG. 9(a).

FIG. 10(a) is a plan view of a filter element, FIG. 10(b) is a front view of the filter element, FIG. 10(c) is a bottom plan view of the filter element, and FIG. 10(d) is a cross-sectional view of the filter element taken along a line H-H in FIG. 10(a).

FIG. 11(a) is a plan view of a lid body, FIG. 11(b) is a front view of the lid body, FIG. 11(c) is a bottom plan view of the lid body, and FIG. 11(d) is a cross-sectional view of the lid body taken along a line I-I in FIG. 11(a).

FIG. 12(a) is a plan view of the μ-TAS device body in which the device C having a solid-liquid separation function is incorporated, and FIG. 12(b) is a cross-sectional view of the μ-TAS device body taken along a line J-J in FIG. 12(a) in an enlarged manner.

FIG. 13(a) is a plan view of another lid body, FIG. 13(b) is a front view of the lid body, FIG. 13(c) is a bottom plan view of the lid body, and FIG. 13(d) is a cross-sectional view of the lid body taken along a line K-K in FIG. 13(a).

FIG. 14(a), FIG. 14 (b) and FIG. 14 (c) are cross-sectional views of respectively different lid bodies taken along a line J-J in FIG. 12(b). In the respective drawings, the depiction of a filter portion of the filter element is omitted.

FIG. 15(a) is a schematic cross-sectional view showing, in an enlarged manner, an essential part of a cross section of the structure including a filter portion where a blood filter body is formed by exposure with a UV light irradiated from a lower surface of a glass substrate. FIG. 15(b) is a plan view of the blood filter body. FIG. 15(c) is a plan view of a half of the blood filter body obtained by halving the blood filter body in FIG. 15(b) in the longitudinal direction along a line d-d. FIG. 15(d) is a cross-sectional view of the blood filter body taken along a line d-d in FIG. 15(b).

FIG. 16(a) is a plan view showing the structure where a PDMS film is mounted on the half of the blood filter body obtained by halving the blood filter body in the longitudinal direction in a state where an edge portion of the PDMS film overlaps the blood filter body at a position 100 μm toward a depth side from an edge portion of the blood filter body where the filter portion is formed. FIG. 16(b) is a front view of the structure shown in FIG. 16(a), and FIG. 16(c) is a cross sectional view of an essential part in FIG. 16(b) taken along a line c-c.

FIG. 17 is a microscope photograph obtained by observing an experimental specimen using a microscope.

FIG. 18 is a microscope photograph showing a manner where red blood corpuscle components and blood plasma components are separated from blood using the device having a solid-liquid separation function shown in FIG. 6.

FIG. 19 is a microscope photograph showing a part of FIG. 18 in an enlarged manner.

### MODE FOR CARRYING OUT THE INVENTION

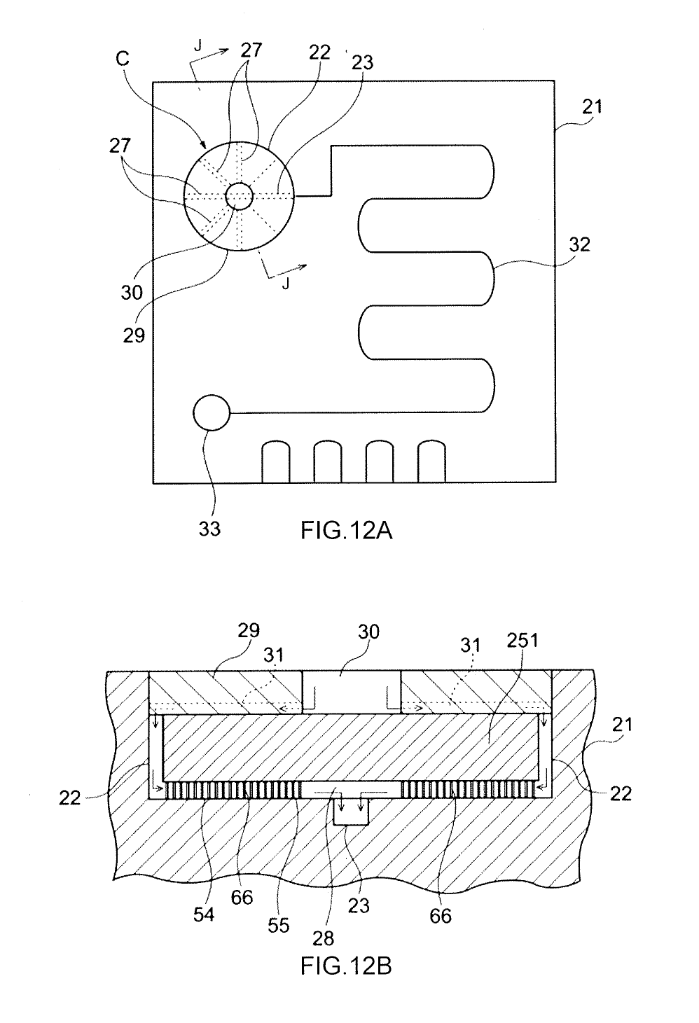

One example of a mode for carrying out the present invention is explained in conjunction with drawings. In this example, a device C having a solid-liquid separation function is, as shown in FIG. 12, used in a state where the device C is incorporated into a μ-TAS (Micro Total Analysis Systems) device body 21. The device C is explained along with one example of a manufacturing method of the device C.

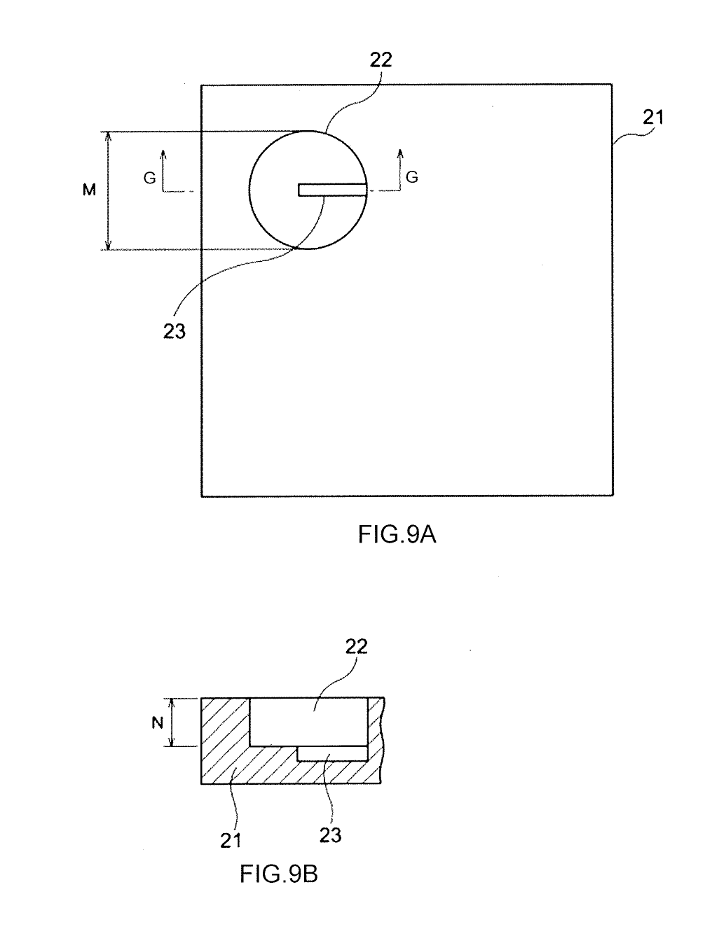

FIG. 9(a) is a plan view of the μ-TAS device body 21 into which the device C having a solid-liquid separation function is incorporated, and FIG. 9(b) is a cross-sectional view of the μ-TAS device body 21 taken along a line G-G in FIG. 9(a). A cylindrically recessed portion 22 is formed in the μ-TAS device body 21. Assume that an inner diameter of the recessed portion 22 is M and a depth of the recessed portion 22 is N. At least one discharge groove 23 is formed on an inner bottom surface of the recessed portion 22 in a state where the discharge groove 23 extends from a center portion to a circumference portion of the inner bottom surface. As described later, a separated liquid is discharged through the discharge groove 23.

The device C having the solid-liquid separation function is assembled such that, as described later, firstly, a filter element is fitted into the cylindrically recessed portion 22 formed in the μ-TAS device body 21 and, next, a lid body is fitted in the recessed portion 22 in a state where the lid body is placed on the filter element.

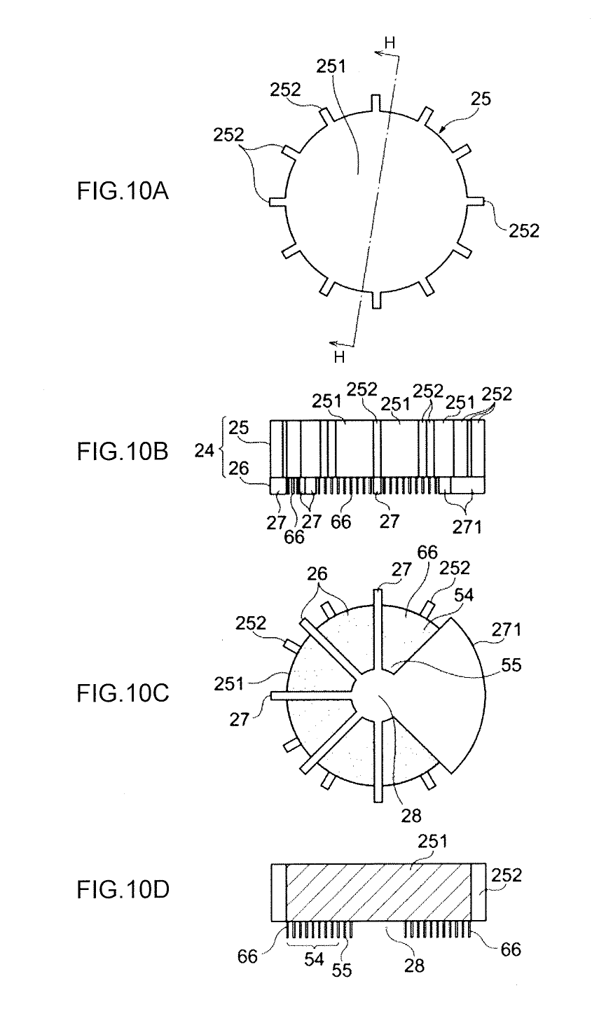

FIG. 10(a) is a plan view of the filter element 24, FIG. 10(b) is a front view of the filter element 24, FIG. 10(c) is a bottom plan view of the filter element 24, and FIG. 10(d) is a cross-sectional view of the filter element 24 taken along a line H-H in FIG. 10(a). The filter element 24 is constituted of a filter element base body 25 and a filter portion 26 constituted of a large number of columnar bodies 66 which are arranged on a lower surface of the filter element base body 25 and extend in the downward direction (in FIG. 10(b) and FIG. 10(d), respective columnar bodies 66 being expressed schematically).

The filter element base body 25 is constituted of a circular disk 251 and twelve side surface ribs 252, 252 . . . which are formed on the periphery of the filter element base body 25 at intervals of 30 degrees in the circumferential direction. The side surface ribs 252 are provided for enabling the mounting of the filter element 24 such that, in fitting the filter element 24 into the cylindrically recessed portion 22 formed in the μ-TAS device body 21, the filter element 24 is brought into close contact with the cylindrically recessed portion 22 so that the filter element 24 becomes immovable. A total diameter which is the sum of a diameter of the circular disk 251 and radial protruding lengths of the side surface ribs 252 arranged opposite to each other is set equal to the inner diameter M of the recessed portion 22 or set slightly larger than the inner diameter M of the recessed portion 22 so that the filter element can be fixed to the recessed portion 22 with slight deformation by being pushed into the recessed portion 22 at the time of mounting.

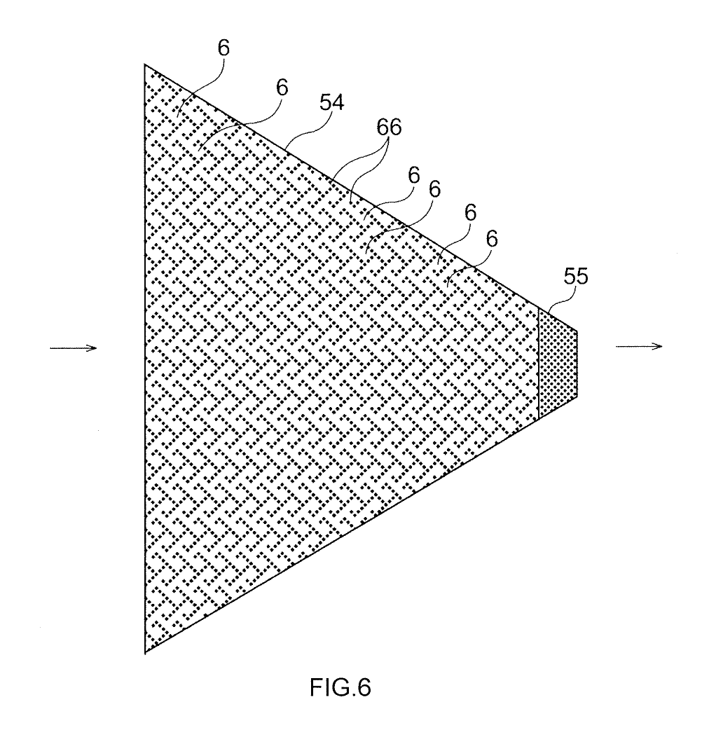

As shown in FIG. 10 (c), the filter portion 26 includes five partition plates 27, 27 . . . in total which are arranged at intervals of 45 degrees in the circumferential direction and one wide partition plate 271 corresponding to approximately one fourth of a circle. In a portion of the filter portion 26 corresponding to approximately one eighth of the circle which is defined by the partition plates 27, 27 arranged adjacent to each other, a trunk portion 54 of a separation portion 5 where a large number of solid trapping portions 6, 6, 6 . . . each of which is constituted of a large number of columnar bodies 66, 66, 66 . . . are formed and a final trapping portion 55 which is constituted of rows of columnar bodies shown in FIG. 6 are provided. In FIG. 10(c), for the sake of convenience, the respective columnar bodies 66 is schematically indicated by dots, and the distribution density of dots in the final trapping portion 55 is set higher than the distribution density of dots in the trunk portion 54. However, the above-mentioned separation portion is not formed on a filter portion of the filter which is positioned above the discharge groove 23 formed on the inner bottom surface of the recessed portion 22 when the filter element 24 is fitted into the cylindrically recessed portion 22 formed in the μ-TAS device body 21. A height of the partition plate 27 is set equal to or slightly smaller than a length of the columnar body 66. Further, as can be understood from FIG. 10(d), a cylindrical space 28 is formed at a center portion of the filter portion 26.

The followings are one example of a size of rows of columnar bodies 66 which constitute the trunk portion 54 of the separation portion 5 and the final trapping portion 55 of the separation portion 5 in using the device C of this embodiment for obtaining blood plasmas by separating blood corpuscles from blood.

Rows of columnar bodies 66 in the trunk portion 54 of the separation portion 5: rows formed of columnar bodies 66 each of which is formed of a square pillar having dimensions of 3.4 μm×3.4 μm>10 μm (height)

A width of the flow passage where the barrier wall in the separation portion 5 is formed of a row of columnar bodies 66: 7 μm

An interval between the columnar bodies 66 arranged adjacent to each other which form the barrier wall: 0.86 μm

An interval between the columnar bodies arranged adjacent to each other which form the partition wall in the solid trapping portion in the separation portion 5: 0.88 μm

The solid trapping portion in the separation portion 5: a shape being a rectangular shape, an interval between the columnar bodies at the inlet portion being 7 μm, a width of the solid trapping portion being 12 μm, and a depth of the solid trapping portion being 12 μm

Rows of columnar bodies in the final trapping portion 55 of the separation portion 5: rows formed of columnar bodies each of which is a square pillar having dimensions of 3.4 μm×3.4 μm×10 μm (height), an interval between the columnar bodies arranged adjacent to each other being 0.86 μm

Although a manufacturing method of the filter element 24 is not limited, the filter element 24 can be manufactured by using, for example, a method which includes a photolithography process or a method where an object having a shape of a body is formed by photolithography, the object is used as a mold, or a mold is formed by applying electroless plating to the object using nickel phosphor or the like, uncured monomer, oligomer, resin or the like in a liquid form is filled into the mold, and the filled material is cured with heat, radiation rays or the like thus forming the body. Further, the filter element 24 can be manufactured also by injection molding using a thermoplastic resin.

In this embodiment, with respect to the method of manufacturing the filter element 24, the filter element 24 is manufactured through the following photolithography steps.

### 1) First Photoresist Layer Coating Step

A first photoresist layer is formed by coating on a glass substrate having a thickness of 1 mm which is cleaned by a conventional method. As a resist, SU-8 (brand name) (made by Nippon Kayaku Co., Ltd.) which is an acrylic high-aspect-ratio resist is used, and the first photoresist layer having a thickness of approximately 10 mm is formed by coating using a spin coater (type: MS-A100 made by MIKASA CO., LTD).

### 2) Prebaking

The first photoresist layer is prebaked by heating on a hotplate at a temperature of 65° C. for 4 minutes and, then, at a temperature of 95° C. for 7 minutes. Due to such prebaking, a solvent contained in the photoresist is evaporated.

### 3) Exposure Step 1

UV light is irradiated onto the first photoresist layer under an irradiation condition of 5 to 10 mj/cm². Because of such irradiation, the first photoresist layer is exposed thus preparing a filter element base body 25.

### 4) Second Photoresist Layer Coating Step

A second photoresist layer is formed by coating on the first photoresist layer. As a resist, in the same manner as the first photoresist layer, SU-8 (brand name) (made by Nippon Kayaku Co., Ltd.) is used, and the second photoresist layer having a thickness of approximately 10 μm is formed by coating using a spin coater (type: MS-A100 made by MIKASA CO., LTD).

### 5) Prebaking

The second photoresist layer is prebaked by heating on a hotplate at a temperature of 65° C. for 4 minutes and, then, at a temperature of 95° C. for 7 minutes. Due to such prebaking, a solvent contained in the photoresist is evaporated.

### 6) Exposure Step 2

In a state where a photo mask is placed on the above-mentioned second photoresist layer using a mask aligner (type: MA-200 made by MIKASA CO., LTD), UV light is irradiated under an irradiation condition of 3 to 8 mj/cm². Because of such irradiation using the photo mask, portions of the second photoresist layer corresponding to portions of the trunk portion 54 of the separation portion 5 except for the rows of columnar bodies 66 and portions of the final trapping portion 55 except for the rows of columnar bodies are not exposed, and the rows of columnar bodies 66 in the trunk portion 54 of the separation portion 5, the rows of columnar bodies in the final trapping portion 55 of the separation portion 5, the partition plates 27 and the partition plate 271 are exposed.

### Postbaking

The second photoresist layer is post-baked by heating on the hotplate at a temperature of 65° C. for 1 minute and, then, at a temperature of 95° C. for 3 minutes. Due to such postbaking, cross-linking of the photoresist which is exposed (sensitized) is accelerated, and the adhesion strength between the glass substrate and the photoresist is also enhanced.

### 8) Developing Step

A developing process and rinsing are performed in a developer (SU-8 made by Nippon Kayaku Co., Ltd.) using a petri dish so as to dissolve the above-mentioned portions of the photoresist layer which are shielded by masking (portions which are not exposed). Next, drying is performed using an air spray. Due to such processing, the filter element 24 is formed in a state where the filter element base body 25 is formed on the glass substrate, and the rows of columnar bodies 66 in the trunk portion 54 of the separation portion 5, the rows of columnar bodies in the final trapping portion 55 of the separation portion 5, the partition plates 27 and the partition plate 271 are formed on the filter element base body 25.

Although sizes of respective portions of the obtained filter element are substantially equal to designed values,. a size of a horizontal surface of the columnar body in the vicinity of an uppermost portion is smaller than 3.4 μm×3.4 μm, while a size of a horizontal surface of the columnar body in the vicinity of a lowermost portion is close to 3.4 μm×3.4 μm. Accordingly, in the obtained device having a solid-liquid separation function, an interval between lower portions (proximal portions) of the columnar bodies forming the solid trapping portion which are arranged adjacent to each other is close to 1.7 μm, and an interval between distal end portions of the columnar bodies forming the solid trapping portion which are arranged adjacent to each other is larger than 1.7 μm. The glass substrate which is used in the above-mentioned processing is not removed from the filter element 24, and is used as a part of the filter element base body 25 of the filter element 24 without modification.

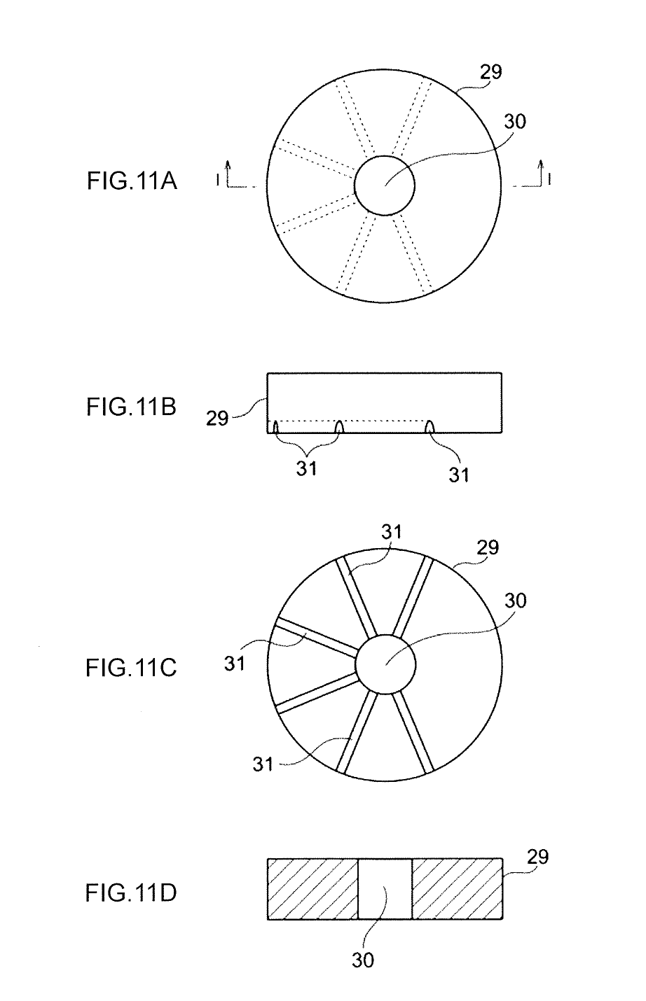

FIG. 11(a) is a plan view of a lid body 29, FIG. 11(b) is a front view of the lid body 29, FIG. 11 (c) is a bottom plan view of the lid body 29, and FIG. 11(d) is a cross-sectional view of the lid body 29 taken along a line I-I in FIG. 11 (a). The lid body 29 has a disk shape, and a circular hole 30 is formed at a center portion of the lid body 29 in a penetrating manner. Grooves 31, 31 . . . are formed on a lower surface of the lid body 29 at intervals of 45 degrees in the circumferential direction. However, a groove is not formed on a portion of the lower surface of the lid body 29 which is positioned above the discharge groove 23 when the lid body 29 is fitted into the recessed portion 22 formed in the μ-TAS device body 21. A diameter of the lid body 29 is set equal to a diameter M of the recessed portion 22 formed on the μ-TAS device body 21 or set slightly larger than the diameter M of the recessed portion 22 so that the filter element can be fixed to the recessed portion 22 with slight deformation by being pushed into the recessed portion 22 at the time of mounting.

Next, a method of assembling the device C having a solid-liquid separation function is explained. Firstly, the above-mentioned filter element 24 is fitted into the μ-TAS device body 21. Here, the partition plates 27 of the filter element 24 are securely brought into close contact with the inner bottom surface of the μ-TAS device body 21. Next, the lid body 29 is fitted into the recessed portion 22 formed in the μ-TAS device body 21 in a state where the lower surface of the lid body 29 is securely brought into close contact with an upper surface of the filter element base body 25. In fitting the lid body 29 into the recessed portion 22 formed in the μ-TAS device body 21, it is necessary to avoid positions of the grooves 31, 31 . . . formed in the lid body 29 from overlapping with positions of the side surface ribs 252, 252 of the filter element base body 25 and positions of the partition plates 27, 27 of the filter portion 26. In this embodiment, the partition plates 27, 27 are arranged at intervals of 45 degrees in the circumferential direction and hence, the lid body 29 is fitted into the recessed portion 22 such that an angle made by the position of the groove 31, 31 formed in the lid body 29 and the position of the partition plate 27, 27 . . . of the filter portion is set to approximately 22.5 degrees. Due to such a constitution, the positions of the grooves 31, 31 and the positions of the side surface ribs 252, 252 of the filter element base body 25 also do not overlap with each other. It is preferable that the wettability of one face and the wettability of the other face be almost equal with respect to the liquid in the solid-liquid mixture. When there is a difference in wettability between one face and the other face due to the difference in a material which forms a surface, working or the like, it is preferable to bring the wettabilities of both surfaces close to each other using various conventional methods such as surface plasma processing, for example. Accordingly, it is preferable that the wettability of the lower surface of the filter element 24 and the wettability of the inner bottom surface of the μ-TAS device body 21 be close to each other.

FIG. 12 (a) is a plan view of the μ-TAS device body 21 into which the device C having a solid-liquid separation function which is obtained in the above-mentioned manner is incorporated, and FIG. 12 (b) is an enlarged cross-sectional view of the μ-TAS device body 21 taken along a line J-J in FIG. 12(a).

From a viewpoint of making the device more compact, it is preferable that the cylindrically recessed portion 22 formed in the μ-TAS device body 21 have a diameter of 20 mm or less and a depth of 8 mm or less, and it is more preferable that the recessed portion 22 have a diameter of 4 mm or less and a depth of 2 mm or less.

The separation of the solid-liquid mixture using the device C having a solid-liquid separation function is explained in conjunction with FIG. 12(b). For example, a solid-liquid mixture such as blood is put into the device from the circular hole 30 formed in the center portion of the lid body 29. The solid-liquid mixture passes through the grooves 31, 31 . . . formed on the lower surface of the lid body 29, and enters a space defined between the cylindrically recessed portion 22 formed in the μ-TAS device body 21 and the circular disk 251 of the filter element base body. Then, the solid-liquid mixture arrives at a space defined between the recessed portion 22 and the filter portion 26 and, thereafter, the solid-liquid mixture enters the trunk portion 54 of the separation portion 5 where solids having a predetermined size or larger are separated. The obtained liquid passes through the final trapping portion 55 so that solids having a predetermined size or larger which remain by chance are also removed and, thereafter, the liquid arrives at the cylindrical space 28 formed in the center portion of the filter portion 26 and, then, the liquid arrives at the discharge groove 23 formed on the μ-TAS device body 21. Liquids from all separation portions 5, 5 . . . divided from each other are merged again in the space 28 and the discharge groove 23.

After the solid-liquid separation, the liquid which enters the discharge groove 23 flows in the direction toward a back side of a paper on which FIG. 12(b) is drawn, and the liquid is led to a liquid passage indicated by symbol 32 in FIG. 12(a). Various properties of the liquid may be measured during a time where the liquid passes through the passage 32. Symbol 33 indicates an outlet through which liquid is discharged after measurement.

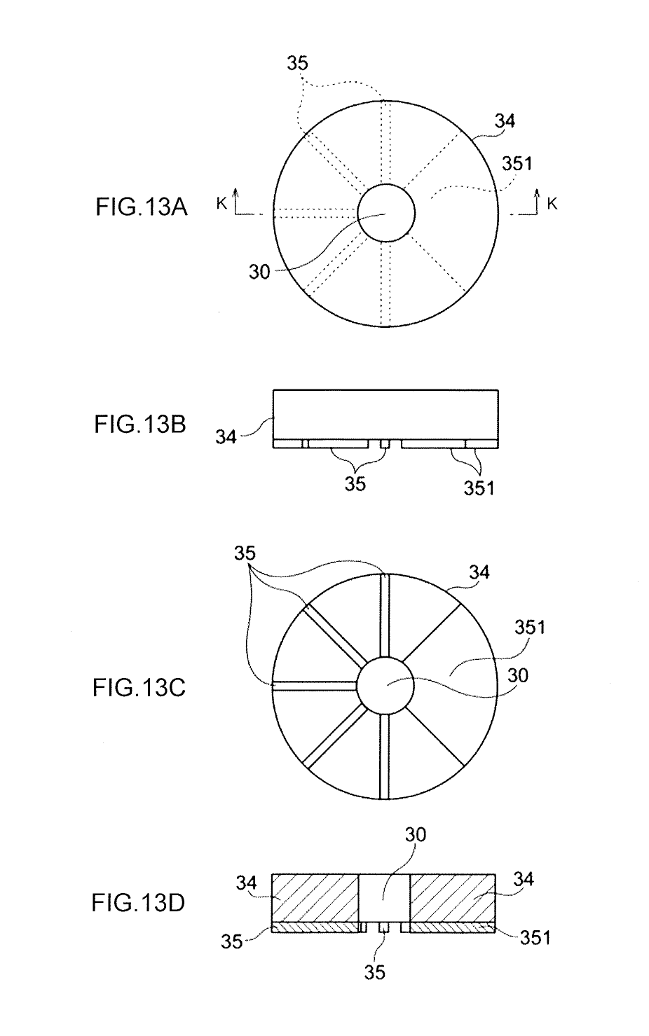

In the above-mentioned device C having a solid-liquid separation function, the grooves 31, 31 . . . are formed on the lower surface of the lid body 29. However, in place of forming the grooves 31, 31 . . . , it may be possible that, as shown in FIG. 13, columnar ribs 35 are formed on the lower surface of the lid body 34 at intervals of 45 degrees in the circumferential direction and one fan-shaped rib 351 is formed on the lower surface of the lid body 34. FIG. 13(a) is a plan view of the lid body 34, FIG. 13(b) is a front view of the lid body 34, FIG. 13(c) is a bottom plan view of the lid body 34, and FIG. 13(d) is a cross-sectional view of the lid body 34 taken along a line K-K in FIG. 13(a). In this case, at the time of starting the use of the device, an amount of solid-liquid mixture which flows through the separation portion 5 can be increased.

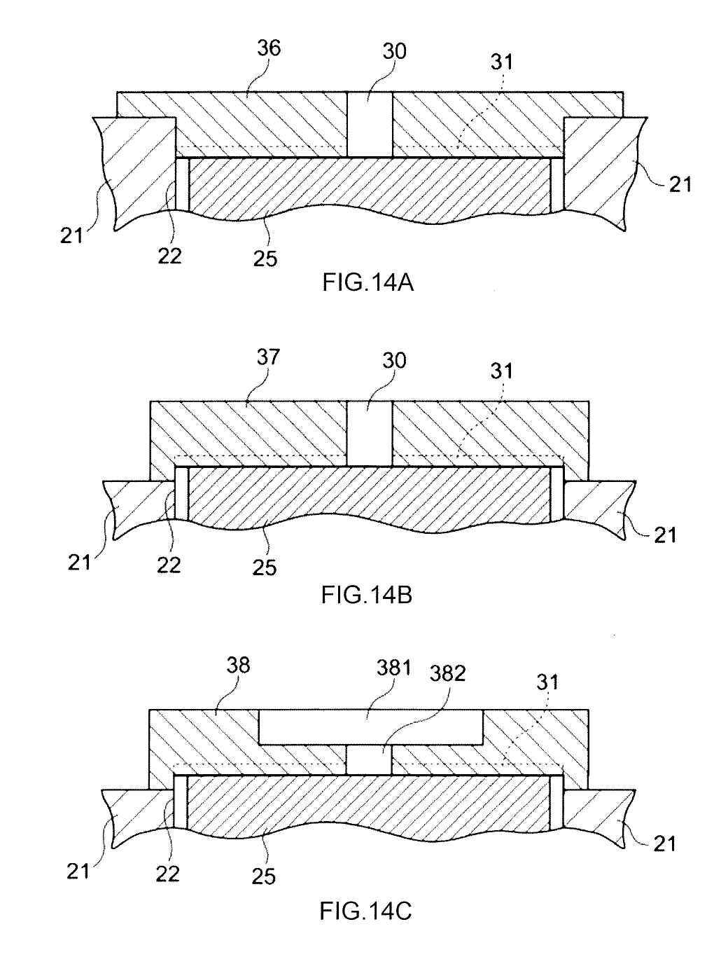

Further, in the device C having a solid-liquid separation function, when the degree of contact between the side surface of the lid body 29 and the side surface of the recessed portion 22 formed in the μ-TAS device body 21 is deteriorated, the solid-liquid mixture may leak through such a portion where the degree of contact is decreased when using the device. To avoid such an incident, it is preferable that a diameter of an upper portion of the lid body 29 be set larger than the diameter of the recessed portion 22 formed in the μ-TAS device body 21. As an example of such a lid body, as in the case of a lid body 36 shown in FIG. 14(a), there is a lid body having a diameter larger than the diameter of the recessed portion 22 formed in the μ-TAS device body 21. Further, as in the case of a lid body 37 shown in FIG. 14(b), a portion of the filter element base body 25 may be formed so as to project upwardly from the recessed portion 22 formed in the μ-TAS device body 21, and the portion of the filter element base body 25 may be covered with a lid body having a diameter larger than the diameter of the recessed portion 22 formed in the μ-TAS device body 21. As in the case of a lid body 38 shown in FIG. 14(c), an upper portion of the lid body having the structure shown in FIG. 14(b) may have the stepped structure which is formed of an upper hole 381 having a larger diameter and a hole 382 having a smaller diameter, a finger may be put into and fixed in the upper hole 381, and a fingertip with the small incision may be pushed into the small hole 382 thus using blood oozed from the fingertip as a solid-liquid mixture specimen.

With respect to the device C having a solid-liquid separation function, based on the same inventive concept, various modifications are conceivable. For example, in the above-mentioned embodiment, the side surface ribs 252, 252, . . . formed on the filter element base body 25 are provided for avoiding the movement of the filter element 24 by bringing the filter element 24 into close contact with the cylindrically recessed portion 22 when the filter element 24 is fitted into the cylindrically recessed portion 22 formed in the μ-TAS device body 21. In place of the side surface ribs 252, 252 . . . , ribs may be formed on an inner wall surface of the recessed portion 22 formed in the μ-TAS device body 21. Alternatively, ribs may be formed on the inner wall surface of the recessed portion 22 as well as on the filter element base body 25.

When a gap is formed between the filter element 24 and the bottom surface of the cylindrically recessed portion 22 formed in the μ-TAS device body 21, there arises a possibility that the solid-liquid mixture goes into the discharge groove 23 without separation. To avoid such a case, a flat film-like body may be provided between the filter element 24 and the bottom surface of the cylindrically recessed portion 22 formed in the μ-TAS device body 21 for giving a role of sealing to the film-shaped body. In this case, a through hole is formed in a center portion of the film-like body, and a separated liquid is made to flow into the discharge groove 23 formed on the μ-TAS device body 21.

Although the grooves 31, 31 . . . are formed on the lower surface of the lid body and the solid-liquid mixture is made to flow into the separation portions 5 through the grooves 31, 31 . . . in the above-mentioned embodiment, the grooves may be formed on the upper surface of the filter element base body 25 in place of being formed on the lower surface of the lid body. Further, in place of the ribs 35 formed on the lower surface of the lid body 34 shown in FIG. 13, ribs may be formed on the upper surface of the filter element base body 25.

In the above-mentioned embodiment, the filter element 24 is constituted of the filter element base body 25, and the filter portion 26 constituted of a large number of columnar bodies 66 which are formed on the lower surface of the filter element base body 25 in a downwardly extending manner. However, the filter element 24 may be constituted of a filter element base body, and a filter portion constituted of a large number of columnar bodies which are formed on an upper surface of the filter element base body in an upwardly extending manner.

In the above-mentioned device C having a solid-liquid separation function, the plurality of solid trapping portions are arranged in the space formed in a sandwiched manner between the lower surface of the filter element base body 25 which constitutes one face and the bottom surface of the recessed portion 22 formed in the μ-TAS device body 21 which constitutes the other face facing one face in an opposed manner, and the solid trapping portion is formed of the rows of columnar bodies 66 extending in the vertical direction toward the other face from one face, and includes the inlet portion, the accommodating portion which accommodates one or more solids which enters the accommodating portion through the inlet portion, and the opening portion which is formed on a downstream side of the accommodating portion and prevents the solid having the fixed size or larger from passing therethrough.

Further, it is preferable that the solid trapping portions and the barrier walls be formed on the lower surface of the filter element base body 25 which constitutes one face, and a material which forms the bottom surface portion of the recessed portion 22 formed in the μ-TAS device body 21 which constitutes the other face is a material softer than a material which forms the rows of columnar bodies which constitute the solid trapping portions and the barrier walls.

Next, an experiment is carried out to observe a state where distal ends of columnar bodies which constitute solid trapping portions and barrier walls are brought into contact with a surface which faces the distal ends of columnar bodies in an opposed manner. The explanation of the experiment is made hereinafter.

### EXPLANATION OF EXPERIMENT

### 1. Preparation of PDMS Film

A KE-17 (silicon resin for a mold, durometer hardness of the resin after curing: approximately 50) produced by Shin-Etsu Silicone Co., Ltd. and a curing agent CAT-RN are mixed to each other, the mixture is dropped on an aluminum plate, and the mixture is cured in a disk-like shape having a diameter of approximately 30 mm and a height of approximately 1.2 mm at a room temperature for 24 hours. A thickness of a polydimethylsiloxane (PDMS) layer after curing is approximately 1.2 mm. Next, the cured PDMS film is cut into a strip shape having dimensions of approximately 30 mm×approximately 10 mm. An obtained film is soft and has minute adhesiveness.

### 2. Preparation of Blood Filter Body

1) A mask is formed on an upper surface of a glass substrate (30 mm×50 mm×thickness of 1 mm) by vapor-depositing gold.

2) A resin layer made of SU-8 (brand name) (made by Nippon Kayaku Co., Ltd.) which is an acrylic high-aspect-ratio is formed on the mask.

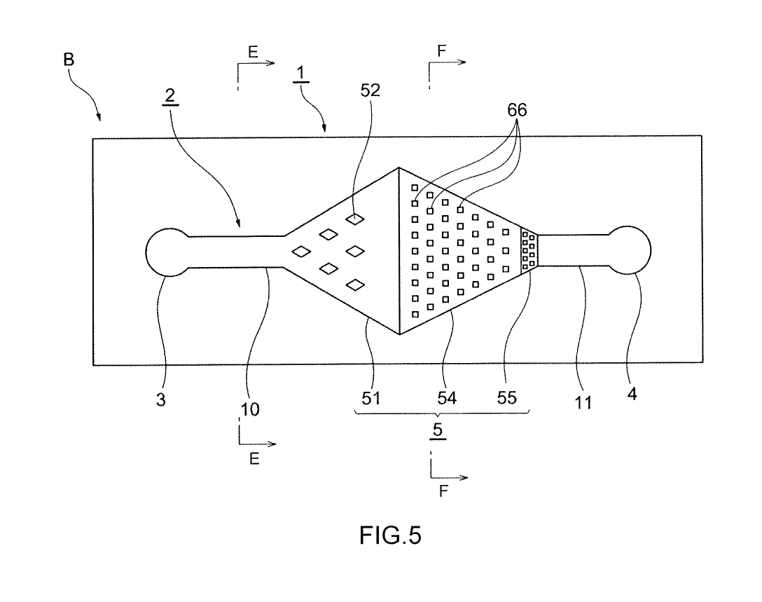

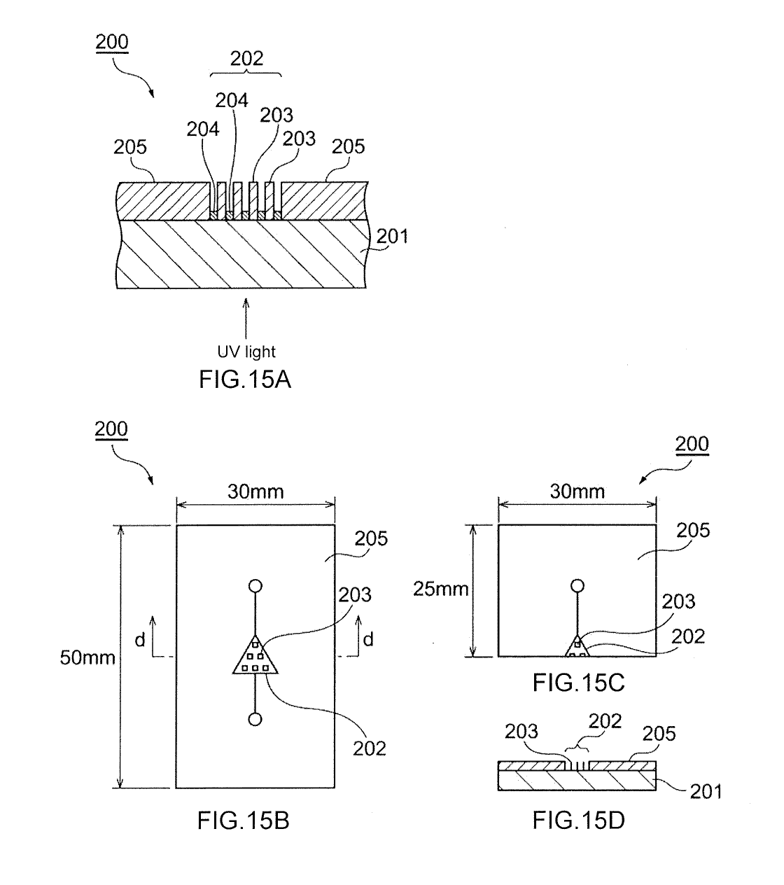

3) A blood filter body is formed by exposing the resin layer from a lower surface of the glass substrate. With respect to a shape of the blood filter body, as shown in FIG. 5, a groove portion which allows a fluid to pass therethrough is formed on a planar body, and such groove portion is constituted of an inlet for a fluid, a separation portion, an outlet for a fluid, and a passage. The separation portion includes a trunk portion in which a large number of solid trapping portions each of which is formed of rows of columnar bodies are formed. The trunk portion is formed of the rows of columnar bodies as shown in FIG. 6, and a width of a region of the separation portion where the solid trapping portions are formed is narrow on a downstream side compared to on an upstream side. This blood filter body is explained hereinafter in conjunction with drawings. FIG. 15(a) is a schematic cross-sectional view showing, in an enlarged manner, an essential part of a cross section of the structure including a filter portion 202 where a blood filter body 200 is formed by exposure with a UV light irradiated from the lower surface of the glass substrate 201. The filter portion 202 is formed of a large number of columnar bodies 203, 203 . . . and a mask 204 which is formed of a vapor-deposited gold film. In FIG. 15(a), the columnar bodies 203, 203 . . . are schematically shown. Symbol 205 indicates a body portion. Here, the columnar body 203 is formed of a square pillar having dimensions of 3.4 μm×3.4 μm×10 μm (height).

3. Preparation of Experimental Specimen

1) FIG. 15(b) is a plan view of the blood filter body 200 having a width of 30 mm and a length of 50 mm which is obtained as described above. Next, by cutting a back surface of the glass substrate 201 at a center portion thereof by a diamond cutter, the blood filter 200 is divided into halves in the longitudinal direction along a line d-d in FIG. 15(b) such that a length of the half becomes 25 mm. FIG. 15(c) is a plan view showing the half of the blood filter body 200 which is obtained by dividing the blood filter body 200 into halves in the longitudinal direction. FIG. 15(d) is a cross-sectional view of the obtained half of the blood filter body 200 taken along the line d-d.

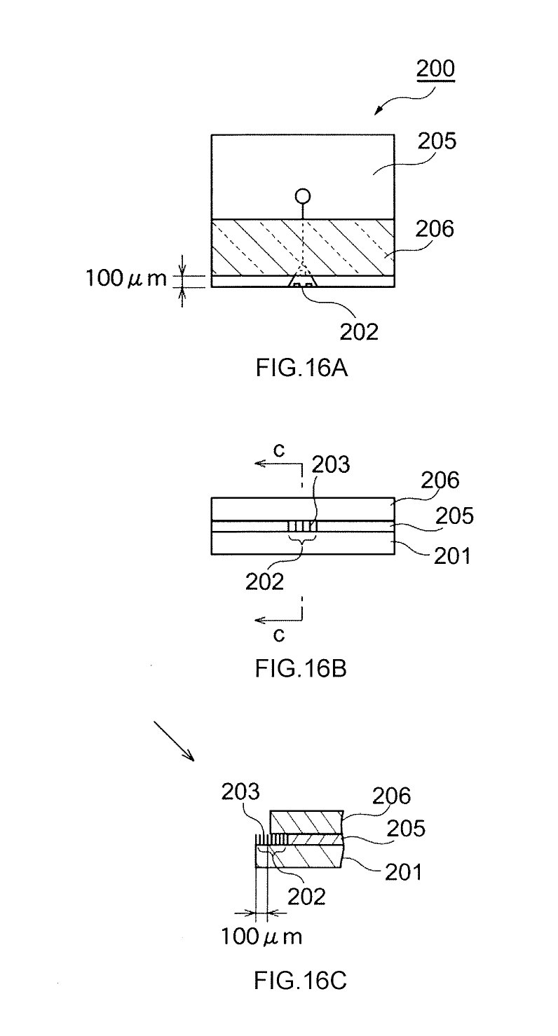

2) Next, as shown in FIG. 16(a), on the half of the blood filter body 200 which is obtained by dividing the blood filter body 200 into halves in the longitudinal direction using the above-mentioned method described in 3, the PDMS film 206 which is obtained in “1. Preparation of PDMS film” is placed such that an edge portion of the PDMS film 206 overlaps with the half of the blood filter body 200 at a position displaced from an edge portion of the half of the blood filter body 200 on a side where the filter portion 202 is formed in the depth direction by 100 μm, and the PDMS film 206 is lightly pressed to the half of the blood filter body 200. An experimental specimen is prepared in such a manner.

FIG. 16(b) is a front view of the experimental specimen shown in FIG. 16(a), and FIG. 16(c) is a cross-sectional view showing an essential part of the experimental specimen taken along a line c-c in FIG. 16(b).

4. Observation Method and Observation Result

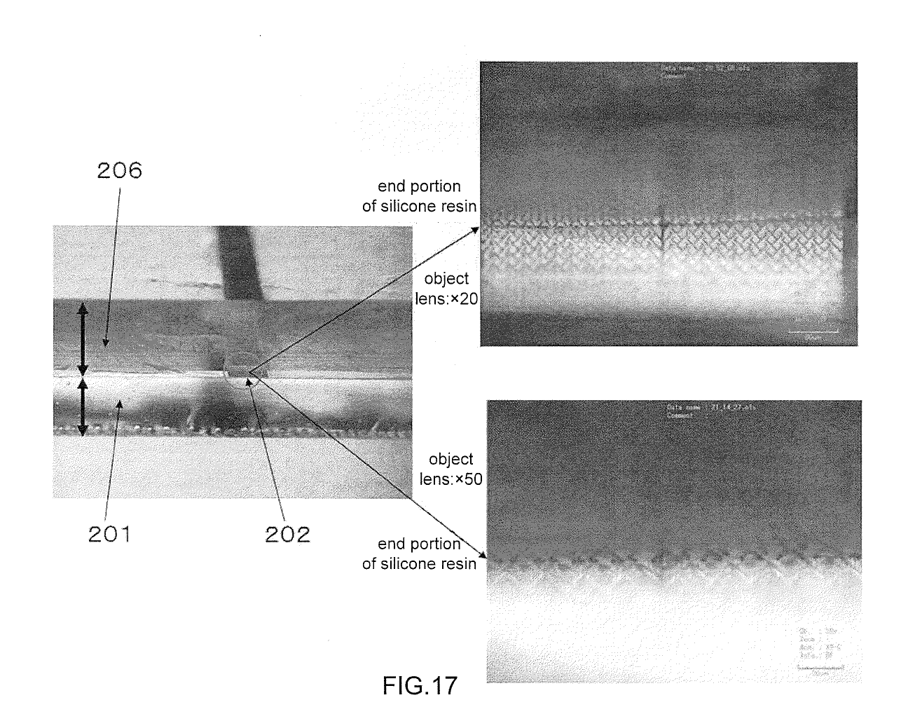

The experimental specimen obtained by the above-mentioned method described in 3. is observed obliquely from above along the observation direction indicated by an arrow in FIG. 16(c). A photograph of the experimental specimen is shown in FIG. 17. A photograph arranged on a left side in FIG. 17 shows the whole image of the experimental specimen, and is taken by observing the experimental specimen using a stereoscopic microscope.

A lower portion of the experimental specimen is formed of a glass substrate (1 mm thickness) 201, and an upper portion of the experimental specimen is formed of a PDMS film (approximately 1.2 mm thickness) 206. As described above, the PDMS film 206 is mounted on the glass substrate 201 with an edge surface thereof displaced from an edge surface of the glass substrate 201 in the depth direction by approximately 100 μm. A portion surrounded by a circle at a center portion of the photograph is a filter portion 202.

A photograph arranged on a right upper side in FIG. 17 is a microscope photograph of the experimental specimen taken by observing the experimental specimen obliquely from above along the observation direction indicated by an arrow in FIG. 16(c) using a scanning-type confocal laser microscope. Here, the above-mentioned microscope is used as a general optical microscope which uses white light without scanning. The imaging condition is that the experimental specimen is imaged by a scanning-type confocal laser microscope in a normal optical stereoscopic mode (object lens: ×20). The photograph of the cross section of the experimental specimen taken in the oblique direction shows a horizontal line which rightwardly extends to a right end of the photograph from a distal end of an arrow which points a portion to which the description “end portion of silicone resin” and the arrow are given. The horizontal line is a borderline indicating a border between the filter portion and the PDMS film on the glass substrate. The labyrinth structure constituted of rows of column bodies of filter portions is observed above and below the boundary line. A scale is displayed at a right lower portion of the photograph, and a full length of a scale display is 80 μm.

A photograph arranged on a right lower side in FIG. 17 is a photograph of the same experimental specimen as the photograph arranged on the right upper side imaged using an object lens ×50. In the same manner as the photograph arranged on the right upper side, a horizontal line rightwardly extends to a right end of the photograph from a distal end of an arrow which points a portion to which the description “end portion of silicone resin” and the arrow are given. The horizontal line is a border line indicating a border between the filter portion and the PDMS film on the glass substrate. In other words, the border line can be also referred to as an end portion of the PDMS film. A scale is displayed at a right lower portion of the photograph, and a full length of a scale display is 30 μm. A portion below the boundary line is the fine structure formed of rows of columnar bodies which constitute the filter portion and appears shining in white. On the other hand, since the PDMS film is transparent in the portion above the boundary line, the fine structure formed of the row of columnar bodies which constitutes the filter portion and is arranged below the PDMS film appears in a see-through manner through the PDMS film. In the observation of the fine structure formed of the row of columnar bodies which constitutes the filter portion in a PDMS film existing portion (an upper side of the photograph) and in a film non-existing portion (a lower side of the photograph) which appear in a vertically arranged manner with a boundary sandwiched therebetween, to focus on a distal end portion of the fine structure (that is, upper end portions of the columnar bodies), it is understood that the distal end portion of the portion below the PDMS film existing portion (the upper side of the photograph) appears dark compared to the distal end portion of the portion below the PDMS film non-existing portion (the lower side of the photograph). It is thought that the distal end portion of the fine structure below the PDMS film existing portion is brought into contact with the PDMS film and hence, the reflection of light is reduced whereby the distal end portion appears in dark. That is, it is confirmed that the PDMS film is brought into contact with the distal end portion of the columnar bodies which constitute the fine structure formed of the row of columnar bodies which constitute the filter portion which is present below the PDMS film.

Next, an experiment for separating red blood corpuscle components and blood plasma components from blood using the device having a solid-liquid separation function shown in FIG. 6 is carried out, and the result of the experiment is presented.

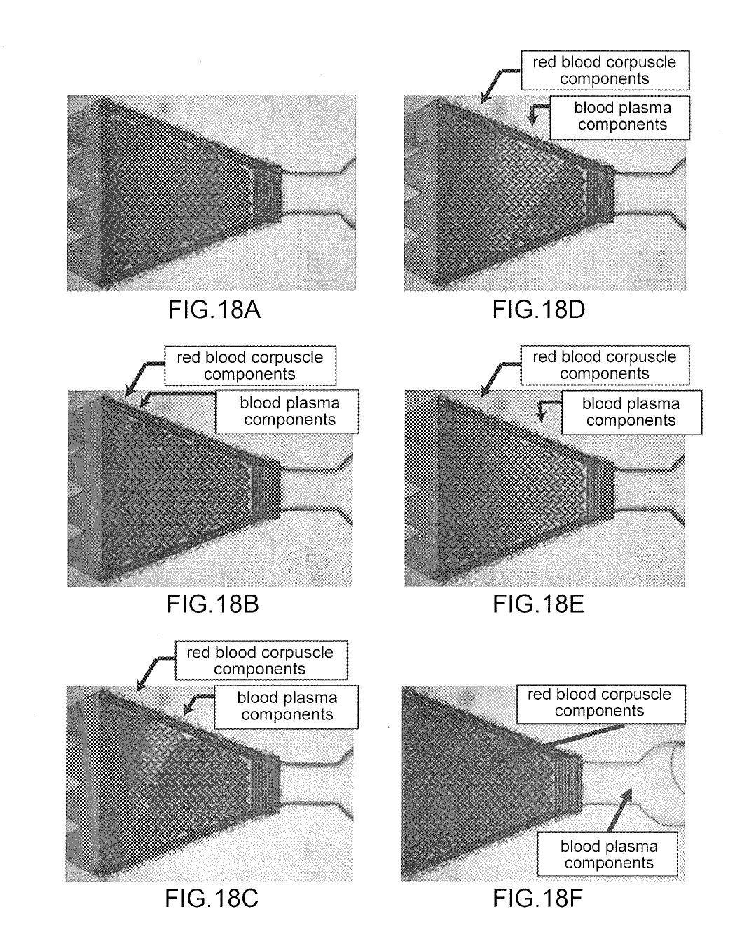

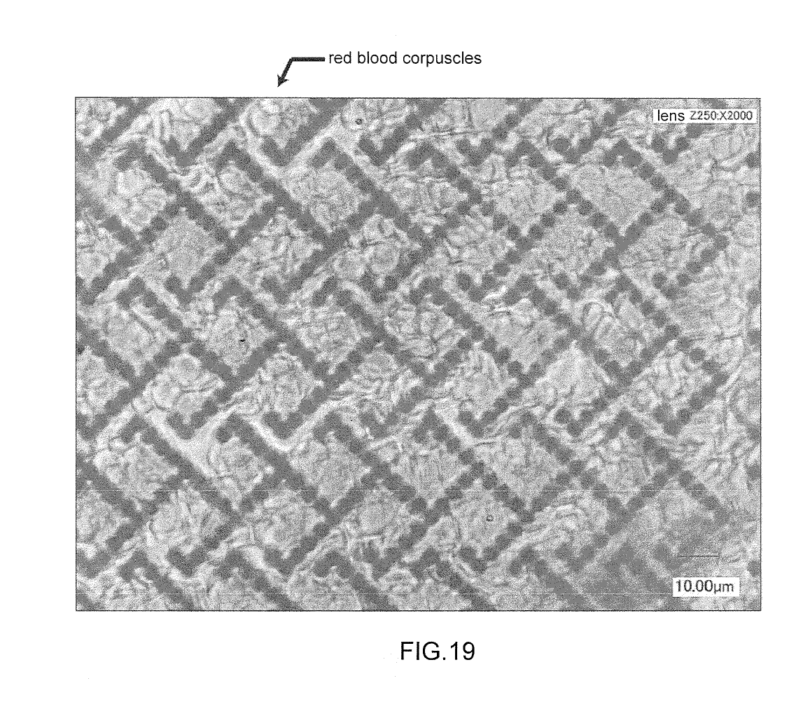

FIG. 18(a) to FIG. 18(f) are microscope photographs showing how red blood corpuscle components and blood plasma components are separated from blood using the device having the solid-liquid separation function shown in FIG. 6. FIG. 19 is a microscope photograph showing the device in FIG. 18 in a partially enlarged manner. Here, in FIG. 18 (b) to FIG. 18 (e), a dark area positioned on a left side of the separation portion 5 is an area where red blood corpuscle components exist, a light area positioned on a right side of the area where red blood corpuscle components exist is an area where blood plasma components exist, and a dark area positioned on a right side of the area where blood plasma components exist is an area where blood components have not reached. FIG. 18(a) shows a state where blood components (red blood corpuscle components and blood plasma components) have not yet reached the separation portion 5. FIG. 18(f) shows a state where an area where red blood corpuscle components exist is distributed over the whole separation portion 5, and most of blood plasma have passed through the separation portion 5.

It is understood from FIG. 18 (a) to FIG. 18(f) that, with the use of the device having a solid-liquid separation function shown in FIG. 6, red blood corpuscle components and blood plasma components can be favorably separated from blood. It is also confirmed that, in such separation of the red blood corpuscle components and the blood plasma components, as shown in FIG. 19, several to ten or more red blood corpuscles are trapped by one solid trapping portion 6.

### INDUSTRIAL APPLICABILITY

The device having a solid-liquid separation function according to the present invention has a function of filtering out solids having a fixed size or larger from a mixture of a liquid and solids and hence, the device can be utilized in a clinical test field as a device having a solid-liquid separation function which has a function of obtaining blood plasmas by separating blood corpuscles from blood, for example. Further, the device can be utilized in a food manufacturing field as a device which recovers enzyme from a fermented food (Japanese sake, for example). Still further, the device is utilized in various industrial fields as a device which recovers fine particles from a solution which contains useful fine particles.

### EXPLANATION OF SYMBOLS

1: body, 2: groove portion, 3: inlet, 4: outlet, 5: separation portion, 51: solid-liquid mixture dispersing portion, 52: columnar obstruction body, 54: trunk portion, 55: final trapping portion, 56: partition portion, 57: merging portion, 6: solid trapping portion, 61: partition wall, 62: inlet portion, 63: accommodating portion, 64: opening portion, 65: projection, 66: columnar body, 7: solid, 91: barrier wall, 92: flow passage inlet, 93: flow passage outlet, 10, 11: passage, 100: lid, 101: lid inlet, 102: lid outlet, 21: μ-TAS device body, 22: recessed portion, 23: discharge groove, 24: filter element, 25: filter element base body, 26: filter portion, 251: disc, 252: side surface rib, 27: partition plate, 271: partition plate, 28: space, 29: lid body, 30: hole, 31: groove, 32: passage, 33: outlet, 34: lid body, 35: columnar rib, 351: fan-shaped rib, 36, 37, 38: lid body, 381: hole, 382: hole, 200: blood filter body, 201: glass substrate, 202: filter portion, 203: columnar body, 204: mask which is formed of gold vapor deposition film, 205: body portion, 206: PDMS film, A, C: device having solid-liquid separation function, B: device on body side of device having solid-liquid separation function

1. A device having a solid-liquid separation function which is provided with a separation portion for separating solids and a liquid from each other by trapping the solids having a fixed size or larger, wherein
a solid-liquid mixture is made to pass through the separation portion toward a downstream from an upstream in the direction from an inlet side to an outlet side of the separation portion,
a plurality of solid trapping portions are arranged in a space which is formed in the separation portion in a sandwiched manner between one face and the other face which face each other,
the solid trapping portion is formed of partition walls extending toward the other face from one face, and includes an inlet portion, an accommodating portion which accommodates one or more solids which enters the accommodating portion through the inlet portion, and an opening portion which is formed on a downstream side of the accommodating portion and prevents the solid having a fixed size or larger from passing therethrough, and
a width of a region of the separation portion where the solid trapping portions are formed is gradually narrowed toward a downstream side from an upstream side.

2. The device having a solid-liquid separation function according to claim 1, wherein the partition wall is formed of a row of columnar bodies or a wall body.

3. The device having a solid-liquid separation function according to claim 1, wherein the partition wall is formed on one face, and a material which forms the other face is a material softer than a material which forms the partition wall.

4. The device having a solid-liquid separation function according to claim 1, wherein the partition wall is formed on one face, and
a material which forms the partition wall is a material softer than a material which forms the other face.

5. The device having a solid-liquid separation function according to claim 1, wherein the partition wall is formed on one face, and
a buffer layer formed of a material softer than a material which forms the other face and a material which forms the partition wall is arranged between the partition wall and the other face.

6. The device having a solid-liquid separation function according to claim 3, wherein the soft material is a resin having hardness of 10 to 100 based on a durometer scale.

7. The device having a solid-liquid separation function according to claim 1, wherein a plurality of flow passages directed toward a downstream from an upstream are formed in the separation portion, the plurality of solid trapping portions which open toward the flow passages are arranged along the flow passages, and one flow passage and another flow passage are defined from each other by a barrier wall or a barrier wall having an opening portion which prevents the solid having the fixed size or larger from passing therethrough.

8. The device having a solid-liquid separation function according to claim 1, wherein the separation portion in which the width of the region where the solid trapping portions are formed is narrow on the downstream side compared to the upstream side is provided in plural on one plane, and liquids from the plurality of separation portions are merged.

9. The device having a solid-liquid separation function according to claim 1, wherein the plurality of separation portions in which the width of the region where the solid trapping portions are formed is narrow on the downstream side compared to the upstream side are gathered thus forming a circular shape or an arcuate shape, and a discharge opening for a merged liquid formed of liquids from the plurality of separation portions is formed at a center portion of a circle or an arc.

10. The device having a solid-liquid separation function according to claim 1, wherein a most downstream portion of the separation portion is configured not to allow the solid having the fixed size or larger from passing therethrough.

11. The device having a solid-liquid separation function according to claim 1, wherein the space is formed in a sandwiched manner between one face and the other face which face each other is 2 to 6 μm.

12. A μ-TAS (Micro Total Analysis Systems) device comprising the device having a solid-liquid separation function according to claim 1 as a part thereof.

13. A solid-liquid separation method which separates solids and a liquid using the device having a solid-liquid separation function according to claim 1, wherein a device having a solid-liquid separation function which is provided with a separation portion having a volume capacity larger than a total volume of solids contained in a solid-liquid mixture to be separated into solids and a liquid is prepared as the separation portion, and the solids and the liquid are separated from each other using the device having a solid-liquid separation function.
